(19) United States
(12) Patent Application Publication
(10) Pub. No.: US 2025/0344651 A1
(43) Pub. Date: Nov. 13, 2025

(54) GROWING MEDIA

(71) Applicant: AEH INNOVATIVE HYDROGEL LTD, Manchester (GB)

(72) Inventor: Beenish SIDDIQUE, Manchester (GB)

(21) Appl. No.: 18/860,960

(22) PCT Filed: Apr. 27, 2023
(86) PCT No.: PCT/EP2023/061119

§ 371 Date: Oct. 28, 2024

(30) Foreign Application Priority Data
Apr. 28, 2022 (GB) 2206246.7

(51) Int. Cl. A01G 24/35; A01G 24/10; A01G 24/20; A01G 24/30

(52) U.S. Cl. CPC A01G 24/35; A01G 24/10; A01G 24/20; A01G 24/30

(57) ABSTRACT

The invention relates to growing media, methods of manufacture thereof and their use in agriculture.

### FIELD

The present disclosure relates to growing media, particularly growing media comprising plant-derived hydrogels. The disclosure further relates to manufacture of these growing media, and to methods of using them in agriculture, particularly vertical farming.

### BACKGROUND

According to the United Nations, the world's population is expected to grow to almost 10 billion by 2050, which will significantly increase agricultural food demand. It is anticipated that the global agricultural system will struggle to meet this demand because it will be severely affected by several challenges including water scarcity, climate change, infertile land, and poor agricultural practices. Also by 2050, it is expected that more than 70% of the world's population will live in cities. Feeding the urban population sustainably, with minimum water in a smaller land area, will almost certainly require use of vertical and greenhouse farming.

Vertical farming produces food on vertically stacked surfaces rather than growing them on large areas of farmland or greenhouses. The intent is to maximise food production per square metre, and it moves farming into a lab-like environment, where environmental conditions are closely controlled to ensure plants get ideal conditions for growth.

Instead of using soil as a growing medium and source of nutrition, vertical farming employs different growing media to provide plants with the necessary nourishment and conditions to thrive. In aeroponics, for example, the plant roots hang suspended in the air while nutrient solutions are delivered via a fine mist. This method of vertical farming is particularly useful where there is limited growing space, and relies on an enclosed air and water/nutrient ecosystem employing little water and direct sun. In hydroponics, plants are grown in nutrient solutions. Plants may be grown simply with their roots exposed to the nutrient solution, or they may be additionally supported by an inert growing medium such as perlite, gravel, or other substrates such as coconut husks (coir), rock wool or peat. Aquaponics is a system of aquaculture in which the waste produced by farmed fish or other aquatic creatures supplies the nutrients for plants grown hydroponically, which in turn purify the water.

Vertical farming has several advantages that make it valuable for the future of the food and agriculture industry-traditional seasonal plants can be grown all year round, exotic fruit and vegetables can be grown anywhere, water consumption can be reduced by 70% to 95% compared to traditional farming, the need for pesticides and chemical fertilisers is drastically reduced, and in a time of climate change, vertical farming eliminates weather uncertainty.

However, many current vertical farming methods employ a growing media containing peat, coir or rock wool, all of which have an environmental impact. Harvesting peat is damaging some of the last remaining wild peatlands in the world, and legislation to ban the use of peat will likely be in force within the next decade. Coir may be a waste product, but it is not necessarily a more environmentally friendly alternative to peat. Processing coir requires large amounts of water, often in an environment where water is already in short supply, and it must be transported large distances to be used in agriculture in countries where coconuts cannot be grown locally. Rock wool is made from spinning molten basaltic rock into fine fibres, and as a consequence its production is very energy intensive. It is also a skin irritant, and bulky to transport and store.

Waste products are also an issue in vertical farming. Most products e.g. rock wool, coir and peat can only be used once before disposal, and whilst peat and coir can be composted, rock wool cannot. Some recycling programs for rock wool exist, but its disposal is a problem since it does not decompose or break down over time. In addition, any good vertical farming substrates like rock wool that stays wet, yet allows oxygen to reach the roots, can also allow mould and algae to build up. This competes with the plants for nutrient solution weakening growth.

There is clear need for innovation in this area to replace the use of peat, coir and rock wool, reduce waste, and combat the problem of unwanted algal growth, without driving up costs.

A super absorbent polymer (SAP) is a polymer that can absorb and retain extremely large amounts of a liquid relative to its own mass. An SAP that absorbs water is classified as a hydrogel when mixed with water, and it absorbs aqueous solutions through hydrogen bonding with water molecules. Although hydrogels potentially possess beneficial properties, they have not yet found commercial application as growing media in vertical farming. Hydrogels typically require a large amount of processing and can be difficult to prepare in the sheet or block form required for hydroponics. In addition, hydrogels also naturally depolymerize over time, a process that can be accelerated in the presence of fertilizer salts, so degradation products need to be carefully considered. Acrylate and acrylamide based hydrogels have been trialled in the vertical farming industry, but they potentially release potassium acrylate and acrylamide as they degrade. Acrylamide is a lethal neurotoxin and has been found to cause cancer in laboratory animals. It readily passes through the skin, and can be inhaled as dust, potentially exposing anything that comes in contact with degrading gels. On an industrial scale this could cause a serious hazard to human health and to the environment.

Plant-derived hydrogels have been evaluated in a variety of different applications in recent years. Several types of hydrogels including cellulose and cellulose derivatives, starch, soy, plant protein, lignin, pectin, carrageenan, or gum-based hydrogels have been evaluated for a variety of different uses, and many of these compounds have been used in food to improve mechanical properties for many years. Methyl cellulose, for example, is a compound derived from cellulose and is widely used as a thickener or emulsifier. Methyl cellulose hydrogels are non-polluting, non-toxic, reusable, and biodegradable and compared to hydrogels that use acrylate or acrylamide as their monomers, cellulose-based hydrogels have better biodegradability and biocompatibility (Cellulose-Based Superabsorbent Hydrogels, 2019, Chapter 7. Benefits of Renewable Hydrogels over Acrylate- and Acrylamide-Based Hydrogels, Abul et al; and Cellulose-based hydrogel materials: chemistry, properties and their prospective applications Prog Biomater. 2018 September; 7:153-174, Fijul Kabir et al).

The present specification describes growing media comprising plant-derived hydrogels that are environmentally friendly and will help meet present and future food demands. They can be used directly as a growth medium, for example in greenhouse and vertical farming, they are reusable, promote early seed germination, and decrease the time needed to produce crops. Use of these hydrogels removes the need for peat, coir or rock wool, thus replacing substrates that have a damaging environmental impact with ones that can be beneficial, whilst combatting the problem of algal growth in vertical farming. After their initial use has been exhausted, these gels can be processed into smaller pieces and spread on agricultural land as a soil improver essentially as a zero-waste product.

### SUMMARY

This specification describes, in part, a growing medium comprising at least 50% w/w plant-derived hydrogel.

This specification also describes, in part, a growing medium comprising methylcellulose and kappa carrageenan.

This specification also describes, in part, a growing medium comprising at least 50% w/w plant-derived hydrogel wherein the plant derived hydrogel comprises methylcellulose, kappa carrageenan and water.

This specification also describes, in part, processes for preparing these growing media.

This specification also describes, in part, the use of these growing media in agriculture.

This specification also describes, in part, kits comprising these growing media and optionally instructions for use.

### DETAILED DESCRIPTION OF THE INVENTION

Many embodiments of the invention are detailed throughout the specification and will be apparent to a reader skilled in the art. The invention is not to be interpreted as being limited to any of the recited embodiments.

“A” means “at least one”. In any embodiment where “a” is used to denote a given material or element, “a” may mean one.

“Comprising” means that a given material or element may contain other materials or elements. In any embodiment where “comprising” is mentioned the given material or element may be formed of at least 10% w/w, at least 20% w/w, at least 30% w/w, or at least 40% w/w of the material or element. In any embodiment where “comprising” is mentioned, “comprising” may also mean “consisting of” (or “consists of”) or “consisting essentially of” (or “consists essentially of”) a given material or element.

“Consisting of” or “consists of” means that a given material or element is formed entirely of the material or element. In any embodiment where “consisting of” or “consists of” is mentioned the given material or element may be formed of 100% w/w of the material or element.

“Consisting essentially of” or “consists essentially of” means that a given material or element consists almost entirely of that material or element. In any embodiment where “consisting essentially of” or “consists essentially of” is mentioned the given material or element may be formed of at least 50% w/w, at least 60% w/w, at least 70% w/w, at least 80% w/w, at least 90% w/w, at least 95% w/w or at least 99% w/w of the material or element.

In any embodiment where “is” or “may be” is used to define a material or element, “is” or “may be” may mean the material or element “consists of” or “consists essentially of” the material or element.

Claims are embodiments. Embodiments may be combined.

### Growing Medium

A growing medium (plural media) is the material in which plants grow. It serves three primary functions: it provides physical support for the plant; facilitates root growth; and delivers nutrients, water, and air to the plant through its roots. Growing media may be adjusted to match the water and nutrient requirements of the plant.

In indoor agriculture, for example vertical farming, typically the growing media will be used to grow plants from seed. Once the seedlings have developed sufficient root structure, the roots penetrate through the bottom of the growing media and access the nutrient solutions supplied by the farming system, e.g. the hydroponic or aeroponic system. Typically the growing media will be such that that the roots penetrate through the bottom of the growing media within a week. At that point the growing media functions primarily as a physical support for the developing plants.

In one embodiment the growing medium does not comprise soil, peat, coir, rock wool or an acrylate or acrylamide based hydrogel.

In one embodiment the growing medium does not comprise soil.

In one embodiment the growing medium does not comprise peat.

In one embodiment the growing medium does not comprise coir.

In one embodiment the growing medium does not comprise rock wool.

In one embodiment the growing medium does not comprise an acrylate or acrylamide based hydrogel.

In one embodiment the growing medium comprises at least 20% w/w plant-derived hydrogel.

In one embodiment the growing medium comprises at least 30% w/w plant-derived hydrogel.

In one embodiment the growing medium comprises at least 40% w/w plant-derived hydrogel.

In one embodiment the growing medium comprises at least 50% w/w plant-derived hydrogel.

In one embodiment the growing medium comprises at least 60% w/w plant-derived hydrogel.

In one embodiment the growing medium comprises at least 70% w/w plant-derived hydrogel.

In one embodiment the growing medium comprises at least 80% w/w plant-derived hydrogel.

In one embodiment the growing medium comprises at least 85% w/w plant-derived hydrogel.

In one embodiment the growing medium comprises at least 90% w/w plant-derived hydrogel.

In one embodiment the growing medium comprises at least 93% w/w plant-derived hydrogel.

In one embodiment the growing medium comprises at least 95% w/w plant-derived hydrogel.

In one embodiment the growing medium comprises at least 98% w/w plant-derived hydrogel.

In one embodiment the growing medium consists of a plant-derived hydrogel.

### Plant-Derived Hydrogels

A plant-derived hydrogel is one in which the hydrogel is formed using a super absorbent polymer derived from a plant (including algae) and water. Derived from a plant means the super absorbent polymer may be extracted from the plant directly, or may be extracted and then modified, e.g. by chemical or biological means.

In one embodiment the plant-derived hydrogel comprises one or more plant-derived super absorbent polymers.

In one embodiment the plant-derived hydrogel consists of one or more plant-derived super absorbent polymers and water.

In one embodiment the plant-derived hydrogel comprises a super absorbent polymer selected from cellulose or a derivative thereof, starch, soy, plant protein, lignin, pectin, carrageenan, or gum.

In one embodiment the plant-derived hydrogel consists of a super absorbent polymer selected from cellulose or a derivative thereof, starch, soy, plant protein, lignin, pectin, carrageenan, or gum, and water.

In one embodiment the plant-derived hydrogel comprises a super absorbent polymer selected from cellulose or a derivative thereof, starch, soy, plant protein, lignin, pectin, carrageenan, and/or gum.

In one embodiment the plant-derived hydrogel consists of a super absorbent polymer selected from cellulose or a derivative thereof, starch, soy, plant protein, lignin, pectin, carrageenan, and/or gum, and water.

In one embodiment the plant-derived hydrogel comprises a super absorbent polymer selected from methyl cellulose, xanthan gum, kappa carrageenan, sodium carboxymethyl cellulose or carboxymethyl cellulose.

In one embodiment the plant-derived hydrogel comprises a super absorbent polymer selected from methyl cellulose, xanthan gum, guar gum, locust bean gum, kappa carrageenan, sodium carboxymethyl cellulose or carboxymethyl cellulose.

In one embodiment the plant-derived hydrogel consists of a super absorbent polymer selected from methyl cellulose, xanthan gum, kappa carrageenan, sodium carboxymethyl cellulose or carboxymethyl cellulose, and water.

In one embodiment the plant-derived hydrogel consists of a super absorbent polymer selected from methyl cellulose, xanthan gum, guar gum, locust bean gum, kappa carrageenan, sodium carboxymethyl cellulose or carboxymethyl cellulose, and water.

In one embodiment the plant-derived hydrogel comprises a super absorbent polymer selected from methyl cellulose, xanthan gum, kappa carrageenan, sodium carboxymethyl cellulose and/or carboxymethyl cellulose.

In one embodiment the plant-derived hydrogel comprises a super absorbent polymer selected from methyl cellulose, xanthan gum, guar gum, locust bean gum, kappa carrageenan, sodium carboxymethyl cellulose and/or carboxymethyl cellulose.

In one embodiment the plant-derived hydrogel consists of a super absorbent polymer selected from methyl cellulose, xanthan gum, kappa carrageenan, sodium carboxymethyl cellulose and/or carboxymethyl cellulose, and water.

In one embodiment the plant-derived hydrogel consists of a super absorbent polymer selected from methyl cellulose, xanthan gum, guar gum, locust bean gum, kappa carrageenan, sodium carboxymethyl cellulose and/or carboxymethyl cellulose, and water.

In one embodiment the plant-derived hydrogel comprises methyl cellulose and kappa carrageenan.

In one embodiment the plant-derived hydrogel consists of methyl cellulose, kappa carrageenan, and water.

In one embodiment the plant-derived hydrogel comprises one plant-derived super absorbent polymer.

In one embodiment the plant-derived hydrogel consists of one plant-derived super absorbent polymer, and water.

In one embodiment the plant-derived hydrogel comprises more than one plant-derived super absorbent polymer.

In one embodiment the plant-derived hydrogel consists of more than one plant-derived super absorbent polymer, and water.

In one embodiment the plant-derived hydrogel comprises at least two plant-derived super absorbent polymers.

In one embodiment the plant-derived hydrogel consists of at least two plant-derived super absorbent polymers, and water.

In one embodiment the plant-derived hydrogel comprises two plant-derived super absorbent polymers.

In one embodiment the plant-derived hydrogel consists of two plant-derived super absorbent polymers, and water.

In one embodiment the plant-derived hydrogel comprises cellulose or a derivative thereof.

In one embodiment the plant-derived hydrogel consists of cellulose or a derivative thereof, and water.

In one embodiment cellulose derivatives may be methyl cellulose, sodium carboxymethyl cellulose, carboxymethyl cellulose, cellulose acetate, ethyl cellulose and/or cellulose nitrate.

Methyl cellulose (or cellulose, methyl ether; methylated cellulose; methylcellulose; or E461) is a chemical compound derived from cellulose. It is a hydrophilic white powder and dissolves in cold water forming a clear viscous solution or gel. It is synthetically produced by heating cellulose with a caustic solution (e.g. a solution of sodium hydroxide) and treating it with methyl chloride. Different kinds of methyl cellulose may be prepared depending on the number of hydroxyl groups substituted by methoxide (—OCH₃ groups). The Degree of Substitution (DS) of a given form of methyl cellulose is defined as the average number of substituted hydroxyl groups per glucose and the theoretical maximum is 3. The average length of the polymer backbones can also differ between preparations.

In one embodiment the plant-derived hydrogel comprises methyl cellulose.

In one embodiment the plant-derived hydrogel comprises pharmaceutical grade methyl cellulose. “Pharmaceutical grade” describes a material for which a chemical purity standard has been established by a recognized national or regional pharmacopeia (e.g., the United States Pharmacopeia (USP).

In one embodiment the plant-derived hydrogel comprises food grade methyl cellulose. Food grade describes a material that is safe for human consumption, particularly a material that complies with US FDA standards.

In one embodiment the plant-derived hydrogel comprises methyl cellulose with a degree of substitution of 1.3-2.6.

In one embodiment the plant-derived hydrogel comprises methyl cellulose with a degree of substitution of 1.7 to 2.2.

In one embodiment the plant-derived hydrogel comprises methyl cellulose with a methoxy content of 25% to 33%.

In one embodiment the plant-derived hydrogel comprises methyl cellulose with a methoxy content of 27.5% to 31.5%.

In one embodiment the plant-derived hydrogel comprises less than 10% w/v methyl cellulose.

In one embodiment the plant-derived hydrogel comprises less than 8% w/v methyl cellulose.

In one embodiment the plant-derived hydrogel comprises less than 6% w/v methyl cellulose.

In one embodiment the plant-derived hydrogel comprises 0.2-6% w/v methyl cellulose.

In one embodiment the plant-derived hydrogel comprises 1-5% w/v methyl cellulose.

In one embodiment the plant-derived hydrogel comprises 0.2-1% w/v methyl cellulose.

In one embodiment the plant-derived hydrogel comprises 1-2% w/v methyl cellulose.

In one embodiment the plant-derived hydrogel comprises 2-3% w/v methyl cellulose.

In one embodiment the plant-derived hydrogel comprises 3-4% w/v methyl cellulose.

In one embodiment the plant-derived hydrogel comprises 4-5% w/v methyl cellulose.

In one embodiment the plant-derived hydrogel comprises 5-6% w/v methyl cellulose.

In one embodiment the plant-derived hydrogel comprises about 0.3% w/v methyl cellulose.

In one embodiment the plant-derived hydrogel comprises about 1% w/v methyl cellulose.

In one embodiment the plant-derived hydrogel comprises about 1.5% w/v methyl cellulose.

In one embodiment the plant-derived hydrogel comprises about 2% w/v methyl cellulose.

In one embodiment the plant-derived hydrogel comprises about 3% w/v methyl cellulose.

In one embodiment the plant-derived hydrogel comprises about 4% w/v methyl cellulose.

In one embodiment the plant-derived hydrogel comprises about 5% w/v methyl cellulose.

Carboxymethyl cellulose (CMC) is a cellulose derivative with carboxymethyl groups (—CH₂—COOH) bound to some of the hydroxyl groups of the glucopyranose monomers that make up the cellulose backbone. It is an is an anionic, water-soluble derivative of cellulose. Typically, CMC products are divided into three different grades: food-grade, pharmaceutical grade, and industrial grade CMC, based on purity and DS.

In one embodiment the plant-derived hydrogel comprises carboxymethyl cellulose.

In one embodiment the plant-derived hydrogel comprises food grade carboxymethyl cellulose.

In one embodiment the plant-derived hydrogel comprises 1-10% w/v carboxymethyl cellulose.

In one embodiment the plant-derived hydrogel comprises about 1-10% w/v carboxymethyl cellulose.

In one embodiment the plant-derived hydrogel comprises 1-3% w/v carboxymethyl cellulose.

In one embodiment the plant-derived hydrogel comprises about 1-3% w/v carboxymethyl cellulose.

Sodium carboxymethyl cellulose is prepared from cellulose by treatment with alkali and monochloro-acetic acid or its sodium salt. It is the sodium salt of the carboxymethyl ether of cellulose. It is used for its thickening and swelling properties in a wide range of complex formulated products for pharmaceutical, food, home, and personal care applications, as well as in paper, water treatment, and mineral processing industries.

In one embodiment the plant-derived hydrogel comprises sodium carboxymethyl cellulose.

In one embodiment the plant-derived hydrogel comprises food grade sodium carboxymethyl cellulose.

In one embodiment the plant-derived hydrogel comprises 1-10% w/v sodium carboxymethyl cellulose.

In one embodiment the plant-derived hydrogel comprises about 1-10% w/v sodium carboxymethyl cellulose.

In one embodiment the plant-derived hydrogel comprises 1-3% w/v sodium carboxymethyl cellulose.

In one embodiment the plant-derived hydrogel comprises about 1-3% w/v sodium carboxymethyl cellulose.

A gum is a sap or other resinous material associated with certain species of the plant kingdom. Gums are often polysaccharide-based and are generally obtained from woody plants, particularly under the bark or as a seed coating. The polysaccharide material is typically of high molecular weight and has the potential to bind water and form gels.

In one embodiment gum may be an alginate, tragacanth, tamarind, sterculia, guar, xanthan or locust bean gum.

In one embodiment gum may be an alginate, tragacanth, tamarind, sterculia, guar, xanthan, locust bean gum or gum arabic.

In one embodiment the plant-derived hydrogel comprises a gum.

In one embodiment the plant-derived hydrogel comprises a food grade gum.

In one embodiment the plant-derived hydrogel comprises 1-10% w/v gum.

In one embodiment the plant-derived hydrogel comprises about 1-10% w/v gum.

In one embodiment the plant-derived hydrogel comprises 1-3% w/v gum.

In one embodiment the plant-derived hydrogel comprises about 1-3% w/v gum.

Xanthan gum is an extracellular polysaccharide secreted by the microorganism Xanthomonas campestris. Commercially it is manufactured by a fermentation process. There are different xanthan gum grades available which can be classified according to their purity, particle size and rheological performance. Dissolved in cold water, xanthan gum produces highly viscous solutions with a weak gel character.

In one embodiment the plant-derived hydrogel comprises xanthan gum.

In one embodiment the plant-derived hydrogel comprises food grade xanthan gum.

In one embodiment the plant-derived hydrogel comprises 0.01-10% w/v xanthan gum.

In one embodiment the plant-derived hydrogel comprises 0.5-3% w/v xanthan gum.

Pectin is a soluble gelatinous polysaccharide obtained from ripe fruits, particularly apple and citrus peel. Pectin can be gelated using calcium chloride (CaCl₂)) for example (J. Mar. Biosci. Biotechnol. 2021, p. 28-47, Vol. 13, No. 1) resulting in calcium pectinate hydrogels.

In one embodiment the plant-derived hydrogel comprises pectin.

In one embodiment the plant-derived hydrogel comprises calcium pectinate.

In one embodiment the plant-derived hydrogel comprises food grade pectin.

In one embodiment the plant-derived hydrogel comprises 1-3% w/v pectin.

In one embodiment the plant-derived hydrogel comprises 1-3% w/v calcium pectinate.

Sodium alginate is a natural polysaccharide extracted from brown algae. It comprises two linked anionic monomers, β-d-mannuronic acid (M) and α-I-guluronic acid (G). The polymer structure is composed of homopolymeric regions of G units (G blocks) and M units (M blocks), interspersed with regions of mixed monomers (MG blocks).

In one embodiment the plant-derived hydrogel comprises sodium alginate.

In one embodiment the plant-derived hydrogel comprises food grade sodium alginate.

In one embodiment the plant-derived hydrogel comprises 0.5-5% w/v sodium alginate.

In one embodiment the plant-derived hydrogel comprises 0.5-3% w/v sodium alginate.

Carrageenans are a family of natural linear sulfated polysaccharides that are extracted from red edible seaweeds. They are categorized into three different classes based on their sulfate content-kappa, iota and lambda. Kappa-carrageenan has one sulfate group per disaccharide, iota-carrageenan has two, and lambda-carrageenan has three. Carrageenan gum is refined form of kappa carrageenan.

In one embodiment the plant-derived hydrogel comprises carrageenan.

In one embodiment the plant-derived hydrogel comprises food grade carrageenan.

In one embodiment the plant-derived hydrogel comprises iota carrageenan.

In one embodiment the plant-derived hydrogel comprises lambda carrageenan.

In one embodiment the plant-derived hydrogel comprises kappa carrageenan.

In one embodiment the plant-derived hydrogel comprises food grade kappa carrageenan.

In one embodiment the plant-derived hydrogel comprises carrageenan gum.

In one embodiment the plant-derived hydrogel comprises 0.01-5% w/v kappa carrageenan.

In one embodiment the plant-derived hydrogel comprises 0.01-5% w/v carrageenan gum.

In one embodiment the plant-derived hydrogel comprises 0.5-3% w/v kappa carrageenan.

In one embodiment the plant-derived hydrogel comprises 0.5-3% w/v carrageenan gum.

In one embodiment the plant-derived hydrogel comprises 1-5% w/v kappa carrageenan.

In one embodiment the plant-derived hydrogel comprises 1-5% w/v carrageenan gum.

In one embodiment the plant-derived hydrogel comprises 1-4% w/v kappa carrageenan.

In one embodiment the plant-derived hydrogel comprises 1-4% w/v carrageenan gum.

In one embodiment the plant-derived hydrogel comprises 1-3% w/v kappa carrageenan.

In one embodiment the plant-derived hydrogel comprises 1-3% w/v carrageenan gum.

In one embodiment the plant-derived hydrogel comprises 4% w/v kappa carrageenan.

In one embodiment the plant-derived hydrogel comprises 4% w/v carrageenan gum.

In one embodiment the plant-derived hydrogel comprises 3% w/v kappa carrageenan.

In one embodiment the plant-derived hydrogel comprises 3% w/v carrageenan gum.

In one embodiment the plant-derived hydrogel comprises 2% w/v kappa carrageenan.

In one embodiment the plant-derived hydrogel comprises 2% w/v carrageenan gum.

In one embodiment the plant-derived hydrogel comprises 1.5% w/v kappa carrageenan.

In one embodiment the plant-derived hydrogel comprises 1.5% w/v carrageenan gum.

In one embodiment the plant-derived hydrogel comprises 1.2% w/v kappa carrageenan.

In one embodiment the plant-derived hydrogel comprises 1.2% w/v carrageenan gum.

In one embodiment the plant-derived hydrogel comprises 1% w/v kappa carrageenan.

In one embodiment the plant-derived hydrogel comprises 1% w/v carrageenan gum.

In one embodiment the plant-derived hydrogel comprises about 4% w/v kappa carrageenan.

In one embodiment the plant-derived hydrogel comprises about 4% w/v carrageenan gum.

In one embodiment the plant-derived hydrogel comprises about 3% w/v kappa carrageenan.

In one embodiment the plant-derived hydrogel comprises about 3% w/v carrageenan gum.

In one embodiment the plant-derived hydrogel comprises about 2% w/v kappa carrageenan.

In one embodiment the plant-derived hydrogel comprises about 2% w/v carrageenan gum.

In one embodiment the plant-derived hydrogel comprises about 1.5% w/v kappa carrageenan.

In one embodiment the plant-derived hydrogel comprises about 1.5% w/v carrageenan gum.

In one embodiment the plant-derived hydrogel comprises about 1.2% w/v kappa carrageenan.

In one embodiment the plant-derived hydrogel comprises about 1.2% w/v carrageenan gum.

In one embodiment the plant-derived hydrogel comprises about 1% w/v kappa carrageenan.

In one embodiment the plant-derived hydrogel comprises about 1% w/v carrageenan gum.

Tragacanth gum is a viscous, odourless, tasteless, water-soluble mixture of polysaccharides obtained from the sap drained from the root of the plant and dried. The gum also seeps from the plant.

In one embodiment the plant-derived hydrogel comprises tragacanth gum.

In one embodiment the plant-derived hydrogel comprises food grade tragacanth gum.

In one embodiment the plant-derived hydrogel comprises 0.01-3% w/v tragacanth gum powder.

In one embodiment the plant-derived hydrogel comprises 1-3% w/v tragacanth gum powder.

Lignin is one of the main components of plant cell wall and it is a natural phenolic polymer with high molecular weight, complex composition and structure.

In one embodiment the plant-derived hydrogel comprises lignin.

In one embodiment the plant-derived hydrogel comprises food grade lignin.

In one embodiment the plant-derived hydrogel comprises 0.01-10% w/v lignin.

In one embodiment the plant-derived hydrogel comprises 1-10% w/v lignin.

In one embodiment the plant-derived hydrogel comprises about 1-10% w/v lignin.

In one embodiment the plant-derived hydrogel comprises 0.01-1% w/v lignin.

In one embodiment the plant-derived hydrogel comprises 1-5% w/v lignin.

In one embodiment the plant-derived hydrogel comprises about 1-5% w/v lignin.

Tamarind gum is a water soluble biopolysaccharide obtained from endosperm of seeds of the tamarind tree (Tamarindus indica linn).

In one embodiment the plant-derived hydrogel comprises tamarind gum.

In one embodiment the plant-derived hydrogel comprises food grade tamarind gum.

In one embodiment the plant-derived hydrogel comprises 0.01-10% w/v tamarind gum.

In one embodiment the plant-derived hydrogel comprises about 0.01-10% w/v tamarind gum.

In one embodiment the plant-derived hydrogel comprises 0.01-5% w/v tamarind gum.

In one embodiment the plant-derived hydrogel comprises about 0.01-5% w/v tamarind gum.

Gum sterculia otherwise known as gum karaya or Indian gum tragacanth, is a vegetable gum produced as an exudate by trees of the genus Sterculia. Chemically, gum karaya is an acid polysaccharide composed of the sugars galactose, rhamnose and galacturonic acid.

In one embodiment the plant-derived hydrogel comprises sterculia gum.

In one embodiment the plant-derived hydrogel comprises food grade sterculia gum.

In one embodiment the plant-derived hydrogel comprises 0.01-10% w/v sterculia gum.

In one embodiment the plant-derived hydrogel comprises about 0.01-10% w/v sterculia gum.

In one embodiment the plant-derived hydrogel comprises 0.01-5% w/v sterculia gum.

In one embodiment the plant-derived hydrogel comprises about 0.01-5% w/v sterculia gum.

Guar gum, also called guaran or gellan gum is a galactomannan polysaccharide extracted from guar beans.

In one embodiment the plant-derived hydrogel comprises guar gum.

In one embodiment the plant-derived hydrogel comprises food grade guar gum.

In one embodiment the plant-derived hydrogel comprises 0.01-10% w/v guar gum.

In one embodiment the plant-derived hydrogel comprises about 0.01-10% w/v guar gum.

In one embodiment the plant-derived hydrogel comprises 0.01-5% w/v guar gum.

In one embodiment the plant-derived hydrogel comprises about 0.01-5% w/v guar gum.

Locust bean gum, also called carob gum, carob bean gum, carobin, or E410, is a galactomannan vegetable gum extracted from the seeds of the carob tree.

In one embodiment the plant-derived hydrogel comprises locust bean gum.

In one embodiment the plant-derived hydrogel comprises food grade locust bean gum.

In one embodiment the plant-derived hydrogel comprises 0.01-10% w/v locust bean gum.

In one embodiment the plant-derived hydrogel comprises about 0.01-10% w/v locust bean gum.

In one embodiment the plant-derived hydrogel comprises 0.01-5% w/v locust bean gum.

In one embodiment the plant-derived hydrogel comprises about 0.01-5% w/v locust bean gum.

Gum arabic also called gum Acacia, gum sudani and Senegal gum is a natural gum consisting of the hardened sap from species of the Acacia tree, Senegalia senegal and Vachellia seyal.

In one embodiment the plant-derived hydrogel comprises gum arabic.

In one embodiment the plant-derived hydrogel comprises food grade gum arabic.

In one embodiment the plant-derived hydrogel comprises 0.01-10% w/v gum arabic.

In one embodiment the plant-derived hydrogel comprises about 0.01-10% w/v gum arabic.

In one embodiment the plant-derived hydrogel comprises 0.01-5% w/v gum arabic.

In one embodiment the plant-derived hydrogel comprises about 0.01-5% w/v gum arabic.

### Additional Ingredients

In one embodiment there may be additional ingredients in the growing medium. These may be incorporated to improve the mechanical properties of the growing medium for example, and/or to enhance its anti-microbial properties.

In one embodiment the growing medium additionally comprises biochar, Psyllium, chitosan, barley seed powder, graphene, graphene oxide, reduced graphene oxide, agar, silk fibroin, genipin, honey, coconut oil, tea tree oil, charcoal, activated charcoal, vanillin, glycerol, clays, jute fibre and/or cotton.

In one embodiment the growing medium additionally comprises biochar, Psyllium, chitosan, barley seed powder, graphene, graphene oxide, reduced graphene oxide, agar, silk fibroin, genipin, honey, coconut oil, tea tree oil, charcoal, activated charcoal, vanillin, glycerol, clays, jute fibre, cotton, salicylic acid, sulfo salicylic acid, ammonium bicarbonate and/or potassium bitartrate.

In one embodiment the growing medium additionally comprises 0.05-50% w/v biochar, Psyllium, chitosan, barley seed powder, graphene, graphene oxide, reduced graphene oxide, agar, silk fibroin, genipin, honey, coconut oil, tea tree oil, charcoal, activated charcoal, vanillin, glycerol, clays, jute fibre and/or cotton.

In one embodiment the growing medium additionally comprises 0.01-50% w/v biochar, Psyllium, chitosan, barley seed powder, graphene, graphene oxide, reduced graphene oxide, agar, silk fibroin, genipin, honey, coconut oil, tea tree oil, charcoal, activated charcoal, vanillin, glycerol, clays, jute fibre, cotton, salicylic acid, sulfo salicylic acid, ammonium bicarbonate and/or potassium bitartrate.

In one embodiment the growing medium additionally comprises 0.05-40% w/v biochar, Psyllium, chitosan, barley seed powder, graphene, graphene oxide, reduced graphene oxide, agar, silk fibroin, genipin, honey, coconut oil, tea tree oil, charcoal, activated charcoal, vanillin, glycerol, clays, jute fibre and/or cotton.

In one embodiment the growing medium additionally comprises 0.01-40% w/v biochar, Psyllium, chitosan, barley seed powder, graphene, graphene oxide, reduced graphene oxide, agar, silk fibroin, genipin, honey, coconut oil, tea tree oil, charcoal, activated charcoal, vanillin, glycerol, clays, jute fibre, cotton, salicylic acid, sulfo salicylic acid, ammonium bicarbonate and/or potassium bitartrate.

In one embodiment the growing medium additionally comprises 0.05-30% w/v biochar, Psyllium, chitosan, barley seed powder, graphene, graphene oxide, reduced graphene oxide, agar, silk fibroin, genipin, honey, coconut oil, tea tree oil, charcoal, activated charcoal, vanillin, glycerol, clays, jute fibre and/or cotton.

In one embodiment the growing medium additionally comprises 0.01-30% w/v biochar, Psyllium, chitosan, barley seed powder, graphene, graphene oxide, reduced graphene oxide, agar, silk fibroin, genipin, honey, coconut oil, tea tree oil, charcoal, activated charcoal, vanillin, glycerol, clays, jute fibre, cotton, salicylic acid, sulfo salicylic acid, ammonium bicarbonate and/or potassium bitartrate.

In one embodiment the growing medium additionally comprises 0.05-20% w/v biochar, Psyllium, chitosan, barley seed powder, graphene, graphene oxide, reduced graphene oxide, agar, silk fibroin, genipin, honey, coconut oil, tea tree oil, charcoal, activated charcoal, vanillin, glycerol, clays, jute fibre and/or cotton.

In one embodiment the growing medium additionally comprises 0.01-20% w/v biochar, Psyllium, chitosan, barley seed powder, graphene, graphene oxide, reduced graphene oxide, agar, silk fibroin, genipin, honey, coconut oil, tea tree oil, charcoal, activated charcoal, vanillin, glycerol, clays, jute fibre, cotton, salicylic acid, sulfo salicylic acid, ammonium bicarbonate and/or potassium bitartrate.

In one embodiment the growing medium additionally comprises 0.05-10% w/v biochar, Psyllium, chitosan, barley seed powder, graphene, graphene oxide, reduced graphene oxide, agar, silk fibroin, genipin, honey, coconut oil, tea tree oil, charcoal, activated charcoal, vanillin, glycerol, clays, jute fibre and/or cotton.

In one embodiment the growing medium additionally comprises 0.01-10% w/v biochar, Psyllium, chitosan, barley seed powder, graphene, graphene oxide, reduced graphene oxide, agar, silk fibroin, genipin, honey, coconut oil, tea tree oil, charcoal, activated charcoal, vanillin, glycerol, clays, jute fibre, cotton, salicylic acid, sulfo salicylic acid, ammonium bicarbonate and/or potassium bitartrate.

In one embodiment the growing medium additionally comprises 1-10% w/v biochar, Psyllium, chitosan, barley seed powder, graphene, graphene oxide, reduced graphene oxide, agar, silk fibroin, genipin, honey, coconut oil, tea tree oil, charcoal, activated charcoal, vanillin, glycerol, clays, jute fibre and/or cotton.

In one embodiment the growing medium additionally comprises 0.01-10% w/v biochar, Psyllium, chitosan, barley seed powder, graphene, graphene oxide, reduced graphene oxide, agar, silk fibroin, genipin, honey, coconut oil, tea tree oil, charcoal, activated charcoal, vanillin, glycerol, clays, jute fibre, cotton, salicylic acid, sulfo salicylic acid, ammonium bicarbonate and/or potassium bitartrate.

In one embodiment the growing medium additionally comprises about 1-10% w/v biochar, Psyllium, chitosan, barley seed powder, graphene, graphene oxide, reduced graphene oxide, agar, silk fibroin, genipin, honey, coconut oil, tea tree oil, charcoal, activated charcoal, vanillin, glycerol, clays, jute fibre and/or cotton.

In one embodiment the growing medium additionally comprises about 0.01-10% w/v biochar, Psyllium, chitosan, barley seed powder, graphene, graphene oxide, reduced graphene oxide, agar, silk fibroin, genipin, honey, coconut oil, tea tree oil, charcoal, activated charcoal, vanillin, glycerol, clays, jute fibre, cotton, salicylic acid, sulfo salicylic acid, ammonium bicarbonate and/or potassium bitartrate.

In one embodiment the growing medium additionally comprises 1-5% w/v biochar, Psyllium, chitosan, barley seed powder, graphene, graphene oxide, reduced graphene oxide, agar, silk fibroin, genipin, honey, coconut oil, tea tree oil, charcoal, activated charcoal, vanillin, glycerol, clays, jute fibre and/or cotton.

In one embodiment the growing medium additionally comprises 0.01-5% w/v biochar, Psyllium, chitosan, barley seed powder, graphene, graphene oxide, reduced graphene oxide, agar, silk fibroin, genipin, honey, coconut oil, tea tree oil, charcoal, activated charcoal, vanillin, glycerol, clays, jute fibre, cotton, salicylic acid, sulfo salicylic acid, ammonium bicarbonate and/or potassium bitartrate.

In one embodiment the growing medium additionally comprises about 1-5% w/v biochar, Psyllium, chitosan, barley seed powder, graphene, graphene oxide, reduced graphene oxide, agar, silk fibroin, genipin, honey, coconut oil, tea tree oil, charcoal, activated charcoal, vanillin, glycerol, clays, jute fibre and/or cotton.

In one embodiment the growing medium additionally comprises about 0.01-5% w/v biochar, Psyllium, chitosan, barley seed powder, graphene, graphene oxide, reduced graphene oxide, agar, silk fibroin, genipin, honey, coconut oil, tea tree oil, charcoal, activated charcoal, vanillin, glycerol, clays, jute fibre, cotton, salicylic acid, sulfo salicylic acid, ammonium bicarbonate and/or potassium bitartrate.

Biochar is a solid material obtained from the carbonization thermochemical conversion of organic material in an oxygen-limited environment. It is produced by the thermal decomposition of organic material (e.g. wood, manure or leaves obtained from agricultural and/or forestry waste) under a limited supply of oxygen, generally at relatively low temperatures (<700° C.) in a controlled process called pyrolysis. This process is similar to the production of charcoal, but the specific process used to make biochar is designed to reduce contamination and safely store carbon. The energy or heat created during pyrolysis can be captured and used as a form of clean energy. Biochar is generally a black, highly porous, lightweight, fine-grained material with a large surface area. Approximately 70% of its composition is carbon with the remaining parts comprising nitrogen, sulphur, hydrogen and oxygen (amongst other elements) as well as minerals from the ash fraction. Biochar's chemical composition varies depending on the organic matter used and the methods employed to make it.

In one embodiment the growing medium additionally comprises biochar.

In any embodiment where biochar is mentioned, the biochar may be produced from wood.

In any embodiment where biochar is mentioned, the biochar may be produced from bamboo.

In any embodiment where biochar is mentioned, the biochar may be produced from manure.

In any embodiment where biochar is mentioned, the biochar may be produced from leaves.

In one embodiment the growing medium additionally comprises up to 10% w/v biochar.

In one embodiment the growing medium additionally comprises up to 8% w/v biochar.

In one embodiment the growing medium additionally comprises up to 6% w/v biochar.

In one embodiment the growing medium additionally comprises 0.01-10% w/v biochar.

In one embodiment the growing medium additionally comprises 0.01-6% w/v biochar.

In one embodiment the growing medium additionally comprises 0.01-4% w/v biochar.

In one embodiment the growing medium additionally comprises 0.01-1% w/v biochar.

In one embodiment the growing medium additionally comprises 0.25-1% w/v biochar.

In one embodiment the growing medium additionally comprises about 1% w/v biochar.

In one embodiment the growing medium additionally comprises about 0.25-1% w/v biochar.

In one embodiment the growing medium additionally comprises 2-3% w/v biochar.

In one embodiment the growing medium additionally comprises 3-4% w/v biochar.

In one embodiment the growing medium additionally comprises 4-5% w/v biochar.

In one embodiment the growing medium additionally comprises 5-6% w/v biochar.

In one embodiment the growing medium additionally comprises about 0.01% w/v biochar.

In one embodiment the growing medium additionally comprises about 1% w/v biochar.

In one embodiment the growing medium additionally comprises about 0.5% w/v biochar.

In one embodiment the growing medium additionally comprises about 2% w/v biochar.

In one embodiment the growing medium additionally comprises about 3% w/v biochar.

In one embodiment the growing medium additionally comprises about 4% w/v biochar.

In one embodiment the growing medium additionally comprises about 5% w/v biochar.

Psyllium is a form of soluble fibre sourced from the husks of the Psyllium (Plantago ovata) seed. Psyllium is soluble in water and it expands to become sticky and glutinous. In the growing medium of the present invention, Psyllium may be added to make gel more adhesive.

In one embodiment the growing medium additionally comprises Psyllium.

In one embodiment the growing medium additionally comprises food grade Psyllium.

In one embodiment the growing medium additionally comprises 0.5-5% w/v Psyllium.

In one embodiment the growing medium additionally comprises 0.5-1% w/v Psyllium.

Chitosan (for example CAS No 9012-76-4) is a linear polysaccharide composed of randomly distributed B-(1→4)-linked D-glucosamine (deacetylated unit) and N-acetyl-D-glucosamine (acetylated unit). It is made by treating the chitin shells of shrimp and other crustaceans with an alkaline substance, such as sodium hydroxide. It is essentially a non-toxic, biocompatible, and biodegradable waste from the seafood industry. In the growing medium of the present invention, chitosan may be added as an anti-transpiring agent and for its anti-fungal properties.

In one embodiment the growing medium additionally comprises chitosan.

In one embodiment the growing medium additionally comprises food grade chitosan.

In one embodiment the growing medium additionally comprises 0.01-5% w/v chitosan.

In one embodiment the growing medium additionally comprises 0.5-3% w/v chitosan.

Barley seed powder, for example black barley seed powder, may be added to the hydrogels of the present invention to increase the water holding capacity.

In one embodiment the growing medium additionally comprises barley seed powder.

In one embodiment the growing medium additionally comprises food grade barley seed powder.

In one embodiment the growing medium additionally comprises 0.5-1% w/v barley seed powder.

Graphene is an allotrope of carbon in the form of a single layer of atoms in a two-dimensional hexagonal lattice in which one atom forms each vertex. It is the basic structural element of other allotropes, including graphite, charcoal, carbon nanotubes and fullerenes. Water-soluble graphene is a kind of graphene with a high hydrophilic and locked molecular structure. The binding capacity of the ions is 4 times that of the common graphene (1000 times of fullerene). Graphene oxide is a form of graphene that includes oxygen functional groups, and has interesting properties that can be different than those of graphene. By reducing graphene oxide, these oxidized functional groups are removed, to obtain a graphene material called reduced graphene oxide. In the growing medium described herein the graphene or reduced graphene oxide can act as an anti-fungal and anti bacterial agent, as well source of carbon for plants.

In one embodiment the growing medium additionally comprises graphene.

In one embodiment the growing medium additionally comprises water soluble graphene.

In one embodiment the growing medium additionally comprises graphene oxide.

In one embodiment the growing medium additionally comprises reduced graphene oxide.

In one embodiment the growing medium additionally comprises 0.1-1% w/v graphene.

In one embodiment the growing medium additionally comprises 0.1-1% w/v water soluble graphene.

In one embodiment the growing medium additionally comprises 0.1-1% w/v graphene oxide.

In one embodiment the growing medium additionally comprises 0.1-1% w/v reduced graphene oxide.

In one embodiment the growing medium additionally comprises 0.001-0.2% w/v graphene.

In one embodiment the growing medium additionally comprises 0.001-0.2% w/v water soluble graphene.

In one embodiment the growing medium additionally comprises 0.001-0.2% w/v graphene oxide.

In one embodiment the growing medium additionally comprises 0.001-0.2% w/v reduced graphene oxide.

Agar is a jelly-like substance comprising polysaccharides obtained from the cell walls of certain species of red algae. It is a mixture of agarose and agaropectin. In the growing medium described herein agar may be added as a stabilising and/or gelling agent.

In one embodiment the growing medium additionally comprises agar.

In one embodiment the growing medium additionally comprises food grade agar.

In one embodiment the growing medium additionally comprises 0.01-5% w/v agar.

In one embodiment the growing medium additionally comprises 1-3% w/v agar.

Silk fibroin (or Sericin Bombyx mori) is a fibrous protein which is produced mainly by silkworms and spiders. In the growing medium described herein it may be added to improve the mechanical properties of the hydrogel.

In one embodiment the growing medium additionally comprises silk fibroin.

In one embodiment the growing medium additionally comprises food grade silk fibroin.

In one embodiment the growing medium additionally comprises 0.5-1% w/v silk fibroin. Genipin is methyl (1R,4aS,7aS)-1-hydroxy-7-(hydroxymethyl)-1,4a,5,7a-tetrahydrocyclopenta[c]pyran-4-carboxylate, a chemical compound found in Genipa americana fruit extract. In the growing medium described herein genipin may act as a cross linker for a polysaccharide increase stability of gel.

In one embodiment the growing medium additionally comprises genipin.

In one embodiment the growing medium additionally comprises food grade genipin.

In one embodiment the growing medium additionally comprises 0.001-0.01% w/v genipin.

Honey is a sweet, viscous food substance made by honey bees and some other bees. In the growing medium described herein it may be added for its anti-microbial properties.

In one embodiment the growing medium additionally comprises honey.

In one embodiment the growing medium additionally comprises food grade honey.

In one embodiment the growing medium additionally comprises manuka honey.

In one embodiment the growing medium additionally comprises 1-3% w/v honey.

In one embodiment the growing medium additionally comprises 1-3% w/v manuka honey.

Coconut oil is an edible oil derived from the wick, meat, and milk of the coconut palm fruit. In the growing medium described herein it may be added for its anti-microbial properties.

In one embodiment the growing medium additionally comprises coconut oil.

In one embodiment the growing medium additionally comprises food grade coconut oil.

In one embodiment the growing medium additionally comprises 0.5-3% w/v coconut oil.

Tea tree oil is an essential oil that comes from the leaves of Melaleuca alternifolia, a small tree native to Queensland and New South Wales, Australia. In the growing medium described herein it may be added for its anti-fungal properties.

In one embodiment the growing medium additionally comprises tea tree oil.

In one embodiment the growing medium additionally comprises food grade tea tree oil.

In one embodiment the growing medium additionally comprises 0.01-2% w/v tea tree oil.

In one embodiment the growing medium additionally comprises 0.01-0.05% w/v tea tree oil.

Charcoal is a lightweight black carbon residue produced by strongly heating wood (or other animal and plant materials) in minimal oxygen to remove all water and volatile constituents. In the growing medium described herein charcoal may be added to enhance antibacterial properties and to prevent light penetrating into the system.

In one embodiment the growing medium additionally comprises charcoal.

In one embodiment the growing medium additionally comprises pharmaceutical grade charcoal.

In one embodiment the growing medium additionally comprises horticultural charcoal.

In one embodiment the growing medium additionally comprises charcoal from British hardwood.

In one embodiment the growing medium additionally comprises 0.01-5% w/v charcoal.

In one embodiment the growing medium additionally comprises 0.1-2% w/v charcoal.

Activated charcoal is charcoal that has been treated with oxygen at very high temperatures to make it more porous. This treatment changes its internal structure, reducing the size of its pores and increasing its surface area. In the growing medium described herein activated charcoal may be added to enhance antibacterial properties and to prevent light penetrating into the system.

In one embodiment the growing medium additionally comprises activated charcoal.

In one embodiment the growing medium additionally comprises pharmaceutical grade activated charcoal.

In one embodiment the growing medium additionally comprises 0.01-5% w/v activated charcoal.

In one embodiment the growing medium additionally comprises 0.1-2% w/v activated charcoal.

In one embodiment the growing medium additionally comprises 0.25% w/v activated charcoal.

In one embodiment the growing medium additionally comprises about 0.25% w/v activated charcoal.

Vanillin is an organic compound with the molecular formula C₈H₈O₃. It is the primary component of the extract of a vanilla bean. In the growing medium described herein that contain chitosan, vanillin may be added to act as a natural antioxidant cross-linking agent, to improve physical, antioxidant and mechanical properties.

In one embodiment the growing medium additionally comprises vanillin.

In one embodiment the growing medium additionally comprises food grade vanillin.

In one embodiment the growing medium additionally comprises 0.01-5% w/v vanillin.

In one embodiment the growing medium additionally comprises 0.2-2% w/v vanillin.

Glycerol (also called glycerine or glycerin) is a simple polyol compound. It is a colourless, odourless, viscous liquid that is sweet-tasting and non-toxic. Glycerol forms inter-molecular hydrogen bonds, especially with water molecules which can increase water content, and enhance viscosity and texture. In the growing medium described herein, glycerol may be added to improve hygroscopic properties.

In one embodiment the growing medium additionally comprises glycerol.

In one embodiment the growing medium additionally comprises food grade glycerol.

In one embodiment the growing medium additionally comprises 0.001-10% w/v glycerol.

In one embodiment the growing medium additionally comprises 1-3% w/v glycerol.

Clays are alumino-silicates with a two-dimensional sheet lattice structure. Clay particles are typically smaller than 2 micron (2×10-3 mm). In one embodiment clay particles are hydrophillic bentonite clay particles. In one embodiment clay particles are montmorillinite clay particles. In one embodiment clay particles are bentonite clay particles. In the growing medium described herein, clay particles may be added as a source of minerals for plants.

In one embodiment the growing medium additionally comprises clay particles.

In one embodiment the growing medium additionally comprises 0.1-5% w/v clay particles.

In one embodiment the growing medium additionally comprises about 0.1-5% w/v clay particles.

Jute fibre (for example Tossa jute (Corchorus olitorius)) is a type of plant fibre primarily sourced from plants belonging to the genus Corchorus. In the growing medium described herein, jute fibre may be added to increase the water absorption.

In one embodiment the growing medium additionally comprises jute fibre.

In one embodiment the growing medium additionally comprises 0.1-10% % w/v jute fibre.

In one embodiment the growing medium additionally comprises about 0.1-10% % w/v jute fibre.

Cotton is a soft, fluffy staple fibre that grows in a protective case around the seeds of the cotton plants of the genus Gossypium in the mallow family Malvaceae. In the growing medium described herein, cotton may be added to increase water absorption and to make the gel more flexible.

In one embodiment the growing medium additionally comprises cotton.

In one embodiment the growing medium additionally comprises 0.1-10% w/v cotton.

In one embodiment the growing medium additionally comprises about 0.1-10% w/v cotton.

In one embodiment the growing medium additionally comprises 5% w/v cotton.

In one embodiment the growing medium additionally comprises about 5% w/v cotton.

In one embodiment the growing medium additionally comprises salicylic acid.

In one embodiment the growing medium additionally comprises 0.01-5% w/v salicylic acid.

In one embodiment the growing medium additionally comprises about 0.01-5% w/v salicylic acid.

In one embodiment the growing medium additionally comprises sulfo salicylic acid.

In one embodiment the growing medium additionally comprises 0.01-5% w/v sulfo salicylic acid.

In one embodiment the growing medium additionally comprises about 0.01-5% w/v sulfo salicylic acid.

In one embodiment the growing medium additionally comprises ammonium bicarbonate.

In one embodiment the growing medium additionally comprises 0.01-5% w/v ammonium bicarbonate.

In one embodiment the growing medium additionally comprises about 0.01-5% w/v ammonium bicarbonate.

In one embodiment the growing medium additionally comprises potassium bitartrate. Potassium bitartrate is also known as potassium hydrogen tartrate and cream of tartar.

In one embodiment the growing medium additionally comprises 0.01-5% w/v potassium bitartrate.

In one embodiment the growing medium additionally comprises about 0.01-5% w/v potassium bitartrate.

### Growing Media Comprising at Least 50% w/w Plant-Derived Hydrogel

In one embodiment, the growing medium comprises one or more plant-derived super absorbent polymers, optional additional ingredients as described herein, made to volume with water.

In one embodiment, the growing medium consists of one or more plant-derived super absorbent polymers, optional additional ingredients as described herein, made to volume with water.

In one embodiment, the growing medium comprises at least 50% w/w plant-derived hydrogel comprising one or more plant-derived super absorbent polymers and water.

In one embodiment, the growing medium comprises at least 50% w/w plant-derived hydrogel comprising one or more plant-derived super absorbent polymers and water; and optional additional ingredients as described herein.

In one embodiment the growing medium comprises methylcellulose, kappa carrageenan and biochar.

In one embodiment the growing medium comprises at least 50% w/w plant-derived hydrogel comprising methylcellulose and kappa carrageenan; and biochar.

In one embodiment the growing medium comprises methylcellulose and kappa carrageenan.

In one embodiment the growing medium comprises at least 50% w/w plant-derived hydrogel comprising methylcellulose and kappa carrageenan.

In one embodiment the growing medium consists of water, methylcellulose, kappa carrageenan and biochar.

In one embodiment the growing medium consists of at least 50% w/w plant-derived hydrogel consisting of water, methylcellulose and kappa carrageenan; and biochar.

In one embodiment the growing medium consists of water, methylcellulose and kappa carrageenan.

In one embodiment the growing medium comprising at least 50% w/w plant-derived hydrogel consists of water, methylcellulose and kappa carrageenan.

In one embodiment the growing medium comprises methylcellulose, kappa carrageenan, biochar and lignin.

In one embodiment the growing medium comprises at least 50% w/w plant-derived hydrogel comprising methylcellulose, kappa carrageenan, biochar and lignin.

In one embodiment the growing medium consists of water, methylcellulose, kappa carrageenan, biochar and lignin.

In one embodiment the growing medium consists of at least 50% w/w plant-derived hydrogel consisting of water, methylcellulose, kappa carrageenan, biochar and lignin.

In one embodiment the growing medium comprises methylcellulose, kappa carrageenan and activated charcoal.

In one embodiment the growing medium comprises methylcellulose, kappa carrageenan and activated charcoal.

In one embodiment the growing medium comprises at least 50% w/w plant-derived hydrogel comprising methylcellulose, kappa carrageenan and activated charcoal.

In one embodiment the growing medium consists of water, methylcellulose, kappa carrageenan and activated charcoal.

In one embodiment the growing medium consists of at least 50% w/w plant-derived hydrogel consisting of water, methylcellulose, kappa carrageenan and activated charcoal.

In one embodiment the growing medium comprises methylcellulose, kappa carrageenan, activated charcoal and sodium bicarbonate.

In one embodiment the growing medium comprises methylcellulose, kappa carrageenan, activated charcoal and sodium bicarbonate.

In one embodiment the growing medium comprises at least 50% w/w plant-derived hydrogel comprising methylcellulose, kappa carrageenan, activated charcoal and sodium bicarbonate.

In one embodiment the growing medium consists of water, methylcellulose, kappa carrageenan, activated charcoal and sodium bicarbonate.

In one embodiment the growing medium consists of at least 50% w/w plant-derived hydrogel consisting of water, methylcellulose, kappa carrageenan, activated charcoal and sodium bicarbonate.

In one embodiment the growing medium comprises methylcellulose, kappa carrageenan, lignin and activated charcoal.

In one embodiment the growing medium comprises methylcellulose, kappa carrageenan, lignin and activated charcoal.

In one embodiment the growing medium comprises at least 50% w/w plant-derived hydrogel comprising methylcellulose, kappa carrageenan, lignin and activated charcoal.

In one embodiment the growing medium consists of water, methylcellulose, kappa carrageenan, lignin and activated charcoal.

In one embodiment the growing medium consists of at least 50% w/w plant-derived hydrogel consisting of water, methylcellulose, kappa carrageenan, lignin and activated charcoal.

In one embodiment the growing medium comprises methylcellulose, kappa carrageenan, locust bean gum and activated charcoal.

In one embodiment the growing medium comprises methylcellulose, kappa carrageenan, locust bean gum and activated charcoal.

In one embodiment the growing medium comprises at least 50% w/w plant-derived hydrogel comprising methylcellulose, kappa carrageenan, locust bean gum and activated charcoal.

In one embodiment the growing medium consists of water, methylcellulose, kappa carrageenan, locust bean gum and activated charcoal.

In one embodiment the growing medium consists of at least 50% w/w plant-derived hydrogel consisting of water, methylcellulose, kappa carrageenan, locust bean gum and activated charcoal.

In one embodiment the growing medium comprises methylcellulose, kappa carrageenan, locust bean gum, salicylic acid and activated charcoal.

In one embodiment the growing medium comprises methylcellulose, kappa carrageenan, locust bean gum, salicylic acid and activated charcoal.

In one embodiment the growing medium comprises at least 50% w/w plant-derived hydrogel comprising methylcellulose, kappa carrageenan, locust bean gum, salicylic acid and activated charcoal.

In one embodiment the growing medium consists of water, methylcellulose, kappa carrageenan, locust bean gum, salicylic acid and activated charcoal.

In one embodiment the growing medium consists of at least 50% w/w plant-derived hydrogel consisting of water, methylcellulose, kappa carrageenan, locust bean gum, salicylic acid and activated charcoal.

In one embodiment the growing medium comprises methylcellulose, kappa carrageenan, locust bean gum and biochar.

In one embodiment the growing medium comprises methylcellulose, kappa carrageenan, locust bean gum and biochar.

In one embodiment the growing medium comprises at least 50% w/w plant-derived hydrogel comprising methylcellulose, kappa carrageenan, locust bean gum and biochar.

In one embodiment the growing medium consists of water, methylcellulose, kappa carrageenan, locust bean gum and biochar.

In one embodiment the growing medium consists of at least 50% w/w plant-derived hydrogel consisting of water, methylcellulose, kappa carrageenan, locust bean gum and biochar.

In one embodiment the growing medium comprises methylcellulose, kappa carrageenan, activated charcoal, xanthan gum, ammonium bicarbonate and potassium bitartrate.

In one embodiment the growing medium comprises methylcellulose, kappa carrageenan, activated charcoal, xanthan gum, ammonium bicarbonate and potassium bitartrate.

In one embodiment the growing medium comprises at least 50% w/w plant-derived hydrogel comprising methylcellulose, kappa carrageenan, activated charcoal, xanthan gum, ammonium bicarbonate and potassium bitartrate.

In one embodiment the growing medium consists of water, methylcellulose, kappa carrageenan, activated charcoal, xanthan gum, ammonium bicarbonate and potassium bitartrate.

In one embodiment the growing medium consists of at least 50% w/w plant-derived hydrogel consisting of water, methylcellulose, kappa carrageenan, activated charcoal, xanthan gum, ammonium bicarbonate and potassium bitartrate.

In one embodiment the growing medium comprises 1-2.5% w/v methylcellulose, 0.5-2% w/v kappa carrageenan and 0.25-0.75% w/v biochar.

In one embodiment the growing medium comprises 0.5-2.5% w/v methylcellulose, 3-5% w/v kappa carrageenan and 0.5-1.5% w/v biochar.

In one embodiment the growing medium comprises at least 50% w/w plant-derived hydrogel comprising 1-2.5% w/v methylcellulose, 0.5-2% w/v kappa carrageenan and 0.25-0.75% w/v biochar.

In one embodiment the growing medium comprises at least 50% w/w plant-derived hydrogel comprising 0.5-2.5% w/v methylcellulose, 3-5% w/v kappa carrageenan and 0.5-1.5% w/v biochar.

In one embodiment the growing medium comprises:
1-2.5% w/v methylcellulose;
0.5-2% w/v kappa carrageenan; and
0.25-0.75% w/v biochar;
made to volume with water.

In one embodiment the growing medium comprises:
0.5-2.5% w/v methylcellulose;
3-5% w/v kappa carrageenan; and
0.5-1.5% w/v biochar;
made to volume with water.

In one embodiment the growing medium comprises at least 50% w/w plant-derived hydrogel comprising:
1-2.5% w/v methylcellulose;
0.5-2% w/v kappa carrageenan; and
0.25-0.75% w/v biochar;
made to volume with water.

In one embodiment the growing medium comprises at least 50% w/w plant-derived hydrogel comprising:
0.5-2.5% w/v methylcellulose;
3-5% w/v kappa carrageenan; and
0.5-1.5% w/v biochar;
made to volume with water.

In one embodiment the growing medium consists of:
1-2.5% w/v methylcellulose;
0.5-2% w/v kappa carrageenan; and
0.25-0.75% w/v biochar;
made to volume with water.

In one embodiment the growing medium consists of:
0.5-2.5% w/v methylcellulose;
3-5% w/v kappa carrageenan; and
0.5-1.5% w/v biochar;
made to volume with water.

In one embodiment the growing medium comprising at least 50% w/w plant-derived hydrogel consists of:
1-2.5% w/v methylcellulose;
0.5-2% w/v kappa carrageenan; and
0.25-0.75% w/v biochar;
made to volume with water.

In one embodiment the growing medium comprising at least 50% w/w plant-derived hydrogel consists of:
0.5-2.5% w/v methylcellulose;
3-5% w/v kappa carrageenan; and
0.5-1.5% w/v biochar;
made to volume with water.

In one embodiment the growing medium comprises about 1-2.5% w/v methylcellulose, about 0.5-2% w/v kappa carrageenan and about 0.25-0.75% w/v biochar.

In one embodiment the growing medium comprises about 0.5-2.5% w/v methylcellulose, about 3-5% w/v kappa carrageenan and about 0.5-1.5% w/v biochar.

In one embodiment the growing medium comprising at least 50% w/w plant-derived hydrogel comprising about 1-2.5% w/v methylcellulose, about 0.5-2% w/v kappa carrageenan and about 0.25-0.75% w/v biochar.

In one embodiment the growing medium comprising at least 50% w/w plant-derived hydrogel comprising about 0.5-2.5% w/v methylcellulose, about 3-5% w/v kappa carrageenan and about 0.5-1.5% w/v biochar.

In one embodiment the growing medium comprises:
about 1-2.5% w/v methylcellulose;
about 0.5-2% w/v kappa carrageenan; and
about 0.25-0.75% w/v biochar;
made to volume with water.

In one embodiment the growing medium comprises:
about 0.5-2.5% w/v methylcellulose;
about 3-5% w/v kappa carrageenan; and
about 0.5-1.5% w/v biochar;
made to volume with water.

In one embodiment the growing medium comprising at least 50% w/w plant-derived hydrogel comprises a plant-derived hydrogel comprising:
about 1-2.5% w/v methylcellulose;
about 0.5-2% w/v kappa carrageenan; and
about 0.25-0.75% w/v biochar;
made to volume with water.

In one embodiment the growing medium comprising at least 50% w/w plant-derived hydrogel comprises a plant-derived hydrogel comprising:
about 0.5-2.5% w/v methylcellulose;
about 3-5% w/v kappa carrageenan; and
about 0.5-1.5% w/v biochar;
made to volume with water.

In one embodiment the growing medium consists of:
about 1-2.5% w/v methylcellulose;
about 0.5-2% w/v kappa carrageenan; and
about 0.25-0.75% w/v biochar;
made to volume with water.

In one embodiment the growing medium consists of:
about 0.5-2.5% w/v methylcellulose;
about 3-5% w/v kappa carrageenan; and
about 0.5-1.5% w/v biochar;
made to volume with water.

In one embodiment the growing medium comprising at least 50% w/w plant-derived hydrogel comprises a plant-derived hydrogel consisting of:
about 1-2.5% w/v methylcellulose;
about 0.5-2% w/v kappa carrageenan; and
about 0.25-0.75% w/v biochar;
made to volume with water.

In one embodiment the growing medium comprising at least 50% w/w plant-derived hydrogel comprises a plant-derived hydrogel consisting of:
about 0.5-2.5% w/v methylcellulose;
about 3-5% w/v kappa carrageenan; and
about 0.5-1.5% w/v biochar;
made to volume with water.

In one embodiment the growing medium comprises 1.5% w/v methylcellulose, 1.5% w/v kappa carrageenan and 0.5% w/v biochar.

In one embodiment the growing medium comprising at least 50% w/w plant-derived hydrogel comprises a plant-derived hydrogel comprising 1.5% w/v methylcellulose, 1.5% w/v kappa carrageenan and 0.5% w/v biochar.

In one embodiment the growing medium comprises:
1.5% w/v methylcellulose;
1.5% w/v kappa carrageenan; and
0.5% w/v biochar;
made to volume with water.

In one embodiment the growing medium comprising at least 50% w/w plant-derived hydrogel comprises a plant-derived hydrogel comprising:
1.5% w/v methylcellulose;
1.5% w/v kappa carrageenan; and
0.5% w/v biochar;
made to volume with water.

In one embodiment the growing medium consists of:
1.5% w/v methylcellulose;
1.5% w/v kappa carrageenan; and
0.5% w/v biochar;
made to volume with water.

In one embodiment the growing medium comprising at least 50% w/w plant-derived hydrogel comprises a plant-derived hydrogel consisting of:
1.5% w/v methylcellulose;
1.5% w/v kappa carrageenan; and
0.5% w/v biochar;
made to volume with water.

In one embodiment the growing medium comprises about 1.5% w/v methylcellulose, about 1.5% w/v kappa carrageenan and about 0.5% w/v biochar.

In one embodiment the growing medium comprises about 1% w/v methylcellulose, about 3.8% w/v kappa carrageenan and about 1% w/v biochar.

In one embodiment the growing medium comprises:
about 1.5% w/v methylcellulose;
about 1.5% w/v kappa carrageenan; and
about 0.5% w/v biochar.
made to volume with water.

In one embodiment the growing medium comprising at least 50% w/w plant-derived hydrogel comprises a plant-derived hydrogel comprising:
about 1.5% w/v methylcellulose;
about 1.5% w/v kappa carrageenan; and
about 0.5% w/v biochar.
made to volume with water.

In one embodiment the growing medium consists of:
about 1.5% w/v methylcellulose;
about 1.5% w/v kappa carrageenan; and
about 0.5% w/v biochar.
made to volume with water.

In one embodiment the growing medium comprising at least 50% w/w plant-derived hydrogel comprises a plant-derived hydrogel consisting of:
about 1.5% w/v methylcellulose;
about 1.5% w/v kappa carrageenan; and
about 0.5% w/v biochar.
made to volume with water.

In one embodiment the growing medium comprises 2% w/v methylcellulose, 1% w/v kappa carrageenan and 0.5% w/v biochar.

In one embodiment the growing medium comprising at least 50% w/w plant-derived hydrogel comprises a plant-derived hydrogel comprising 2% w/v methylcellulose, 1% w/v kappa carrageenan and 0.5% w/v biochar.

In one embodiment the growing medium comprises:
2% w/v methylcellulose;
1% w/v kappa carrageenan; and
0.5% w/v biochar;
made to volume with water.

In one embodiment the growing medium comprising at least 50% w/w plant-derived hydrogel comprises a plant-derived hydrogel comprising:
2% w/v methylcellulose;
1% w/v kappa carrageenan; and
0.5% w/v biochar;
made to volume with water.

In one embodiment the growing medium consists of:
2% w/v methylcellulose;
1% w/v kappa carrageenan; and
0.5% w/v biochar;
made to volume with water.

In one embodiment the growing medium comprising at least 50% w/w plant-derived hydrogel comprises a plant-derived hydrogel consisting of:
2% w/v methylcellulose;
1% w/v kappa carrageenan; and
0.5% w/v biochar;
made to volume with water.

In one embodiment the growing medium comprises about 2% w/v methylcellulose, about 1% w/v kappa carrageenan and about 0.5% w/v biochar.

In one embodiment the growing medium comprising at least 50% w/w plant-derived hydrogel comprises a plant-derived hydrogel comprising about 2% w/v methylcellulose, about 1% w/v kappa carrageenan and about 0.5% w/v biochar.

In one embodiment the growing medium comprises:
about 2% w/v methylcellulose;
about 1% w/v kappa carrageenan; and
about 0.5% w/v biochar;
made to volume with water.

In one embodiment the growing medium comprising at least 50% w/w plant-derived hydrogel comprises a plant-derived hydrogel comprising:
about 2% w/v methylcellulose;
about 1% w/v kappa carrageenan; and
about 0.5% w/v biochar;
made to volume with water.

In one embodiment the growing medium consists of:
about 2% w/v methylcellulose;
about 1% w/v kappa carrageenan; and
about 0.5% w/v biochar;
made to volume with water.

In one embodiment the growing medium comprising at least 50% w/w plant-derived hydrogel comprises a plant-derived hydrogel consisting of:
about 2% w/v methylcellulose;
about 1% w/v kappa carrageenan; and
about 0.5% w/v biochar;
made to volume with water.

In one embodiment the growing medium comprises 1% w/v methylcellulose, 3.8% w/v kappa carrageenan and 1% w/v biochar.

In one embodiment the growing medium comprises:
1% w/v methylcellulose;
3.8% w/v kappa carrageenan; and
1% w/v biochar;
made to volume with water.

In one embodiment the growing medium comprising at least 50% w/w plant-derived hydrogel comprises a plant-derived hydrogel comprising:
1% w/v methylcellulose;
3.8% w/v kappa carrageenan; and
1% w/v biochar;
made to volume with water.

In one embodiment the growing medium consists of:
1% w/v methylcellulose;
3.8% w/v kappa carrageenan; and
1% w/v biochar;
made to volume with water.

In one embodiment the growing medium comprising at least 50% w/w plant-derived hydrogel comprises a plant-derived hydrogel consisting of:
1% w/v methylcellulose;
3.8% w/v kappa carrageenan; and
1% w/v biochar;
made to volume with water.

In one embodiment the growing medium comprising at least 50% w/w plant-derived hydrogel comprises a plant-derived hydrogel comprising about 1% w/v methylcellulose, about 3.8% w/v kappa carrageenan and about 1% w/v biochar.

In one embodiment the growing medium comprises:
about 1% w/v methylcellulose;
about 3.8% w/v kappa carrageenan; and
about 1% w/v biochar.
made to volume with water.

In one embodiment the growing medium comprising at least 50% w/w plant-derived hydrogel comprises a plant-derived hydrogel comprising:
about 1% w/v methylcellulose;
about 3.8% w/v kappa carrageenan; and
about 1% w/v biochar.
made to volume with water.

In one embodiment the growing medium consists of:
about 1% w/v methylcellulose;
about 3.8% w/v kappa carrageenan; and
about 1% w/v biochar.
made to volume with water.

In one embodiment the growing medium comprising at least 50% w/w plant-derived hydrogel comprises a plant-derived hydrogel consisting of:
about 1% w/v methylcellulose;
about 3.8% w/v kappa carrageenan; and
about 1% w/v biochar.
made to volume with water.

In one embodiment the growing medium comprises 0.1-0.5% w/v methylcellulose and 1-1.5% w/v kappa carrageenan.

In one embodiment the growing medium comprises 0.1-1.5% w/v methylcellulose, 3-5% w/v kappa carrageenan and optionally 0.5-1.5 activated charcoal.

In one embodiment the growing medium comprising at least 50% w/w plant-derived hydrogel comprises a plant-derived hydrogel comprising 0.1-0.5% w/v methylcellulose and 1-1.5% w/v kappa carrageenan.

In one embodiment the growing medium comprising at least 50% w/w plant-derived hydrogel comprises a plant-derived hydrogel comprising 0.1-1.5% w/v methylcellulose, 3-5% w/v kappa carrageenan.

In one embodiment the growing medium comprises:
0.1-0.5% w/v methylcellulose; and
1-1.5% w/v kappa carrageenan;
made to volume with water.

In one embodiment the growing medium comprises:
0.1-1.5% w/v methylcellulose;
3-5% w/v kappa carrageenan; and
optionally 0.5-1.5% w/v activated charcoal;
made to volume with water.

In one embodiment the growing medium comprising at least 50% w/w plant-derived hydrogel comprises a plant-derived hydrogel comprising:
0.1-0.5% w/v methylcellulose; and
1-1.5% w/v kappa carrageenan;
made to volume with water.

In one embodiment the growing medium comprising at least 50% w/w plant-derived hydrogel comprises a plant-derived hydrogel comprising:
0.1-1.5% w/v methylcellulose;
3-5% w/v kappa carrageenan; and
optionally 0.5-1.5% w/v activated charcoal;
made to volume with water.

In one embodiment the growing medium consists of:
0.1-0.5% w/v methylcellulose; and
1-1.5% w/v kappa carrageenan;
made to volume with water.

In one embodiment the growing medium consists of:
0.1-1.5% w/v methylcellulose;
3-5% w/v kappa carrageenan; and
optionally 0.5-1.5% w/v activated charcoal;
made to volume with water.

In one embodiment the growing medium comprising at least 50% w/w plant-derived hydrogel comprises a plant-derived hydrogel consisting of:
0.1-0.5% w/v methylcellulose; and
1-1.5% w/v kappa carrageenan;
made to volume with water.

In one embodiment the growing medium comprising at least 50% w/w plant-derived hydrogel comprises a plant-derived hydrogel consisting of:
0.1-1.5% w/v methylcellulose;
3-5% w/v kappa carrageenan; and
optionally 0.5-1.5% w/v activated charcoal;
made to volume with water.

In one embodiment the growing medium comprises about 0.1-0.5% w/v methylcellulose and about 1-1.5% w/v kappa carrageenan.

In one embodiment the growing medium comprises about 0.1-1.5% w/v methylcellulose, about 3-5% w/v kappa carrageenan and optionally about 0.5-1.5% w/v activated charcoal.

In one embodiment the growing medium comprising at least 50% w/w plant-derived hydrogel comprises a plant-derived hydrogel comprising about 0.1-0.5% w/v methylcellulose and about 1-1.5% w/v kappa carrageenan.

In one embodiment the growing medium comprising at least 50% w/w plant-derived hydrogel comprises a plant-derived hydrogel comprising about 0.1-1.5% w/v methylcellulose, about 3-5% w/v kappa carrageenan and optionally about 0.5-1.5% w/v activated charcoal.

In one embodiment the growing medium comprises:
about 0.1-0.5% w/v methylcellulose; and
about 1-1.5% w/v kappa carrageenan;
made to volume with water.

In one embodiment the growing medium comprises:
about 0.1-1.5% w/v methylcellulose;
about 3-5% w/v kappa carrageenan; and
optionally about 0.5-1.5% w/v activated charcoal;
made to volume with water.

In one embodiment the growing medium comprising at least 50% w/w plant-derived hydrogel comprises a plant-derived hydrogel comprising:
about 0.1-0.5% w/v methylcellulose; and
about 1-1.5% w/v kappa carrageenan;
made to volume with water.

In one embodiment the growing medium comprising at least 50% w/w plant-derived hydrogel comprises a plant-derived hydrogel comprising:
about 0.1-1.5% w/v methylcellulose;
about 3-5% w/v kappa carrageenan; and
optionally about 0.5-1.5% w/v activated charcoal;
made to volume with water.

In one embodiment the growing medium consists of:
about 0.1-0.5% w/v methylcellulose; and
about 1-1.5% w/v kappa carrageenan;
made to volume with water.

In one embodiment the growing medium consists of:
about 0.1-1.5% w/v methylcellulose;
about 3-5% w/v kappa carrageenan; and
optionally about 0.5-1.5% w/v activated charcoal;
made to volume with water.

In one embodiment the growing medium comprising at least 50% w/w plant-derived hydrogel comprises a plant-derived hydrogel consisting of:
about 0.1-0.5% w/v methylcellulose; and
about 1-1.5% w/v kappa carrageenan;
made to volume with water.

In one embodiment the growing medium comprising at least 50% w/w plant-derived hydrogel comprises a plant-derived hydrogel consisting of:
about 0.1-1.5% w/v methylcellulose;
about 3-5% w/v kappa carrageenan; and
optionally about 0.5-1.5% w/v activated charcoal;
made to volume with water.

In one embodiment the growing medium comprises 0.3% w/v methylcellulose and 1.2% w/v kappa carrageenan.

In one embodiment the growing medium comprising at least 50% w/w plant-derived hydrogel comprises a plant-derived hydrogel comprising 0.3% w/v methylcellulose and 1.2% w/v kappa carrageenan.

In one embodiment the growing medium comprises:
0.3% w/v methylcellulose; and
1.2% w/v kappa carrageenan;
made to volume with water.

In one embodiment the growing medium comprising at least 50% w/w plant-derived hydrogel comprises a plant-derived hydrogel comprising:
0.3% w/v methylcellulose; and
1.2% w/v kappa carrageenan;
made to volume with water.

In one embodiment the growing medium consists of:
0.3% w/v methylcellulose; and
1.2% w/v kappa carrageenan;
made to volume with water.

In one embodiment the growing medium comprising at least 50% w/w plant-derived hydrogel comprises a plant-derived hydrogel consisting of:
0.3% w/v methylcellulose; and
1.2% w/v kappa carrageenan;
made to volume with water.

In one embodiment the growing medium comprises about 0.3% w/v methylcellulose and about 1.2% w/v kappa carrageenan.

In one embodiment the growing medium comprising at least 50% w/w plant-derived hydrogel comprises a plant-derived hydrogel comprising about 0.3% w/v methylcellulose and about 1.2% w/v kappa carrageenan.

In one embodiment the growing medium comprises:
about 0.3% w/v methylcellulose; and
about 1.2% w/v kappa carrageenan;
made to volume with water.

In one embodiment the growing medium comprising at least 50% w/w plant-derived hydrogel comprises a plant-derived hydrogel comprising:
about 0.3% w/v methylcellulose; and
about 1.2% w/v kappa carrageenan;
made to volume with water.

In one embodiment the growing medium consists of:
about 0.3% w/v methylcellulose; and
about 1.2% w/v kappa carrageenan;
made to volume with water.

In one embodiment the growing medium comprising at least 50% w/w plant-derived hydrogel comprises a plant-derived hydrogel consisting of:
about 0.3% w/v methylcellulose; and
about 1.2% w/v kappa carrageenan;
made to volume with water.

In one embodiment the growing medium comprises 1% w/v methylcellulose, 3.8% w/v kappa carrageenan and optionally 1% w/v activated charcoal.

In one embodiment the growing medium comprising at least 50% w/w plant-derived hydrogel comprises a plant-derived hydrogel comprising 1% w/v methylcellulose, 3.8% w/v kappa carrageenan and optionally 1% w/v activated charcoal.

In one embodiment the growing medium comprises:
1% w/v methylcellulose;
3.8% w/v kappa carrageenan; and
optionally 1% w/v activated charcoal;
made to volume with water.

In one embodiment the growing medium comprising at least 50% w/w plant-derived hydrogel comprises a plant-derived hydrogel comprising:
1% w/v methylcellulose;
3.8% w/v kappa carrageenan; and
optionally 1% w/v activated charcoal;
made to volume with water.

In one embodiment the growing medium consists of:
1% w/v methylcellulose;
3.8% w/v kappa carrageenan; and
optionally 1% w/v activated charcoal;
made to volume with water.

In one embodiment the growing medium comprising at least 50% w/w plant-derived hydrogel comprises a plant-derived hydrogel consisting of:
1% w/v methylcellulose;
3.8% w/v kappa carrageenan; and
optionally 1% w/v activated charcoal;
made to volume with water.

In one embodiment the growing medium comprises about 1% w/v methylcellulose, about 3.8% w/v kappa carrageenan and optionally about 1% w/v activated charcoal.

In one embodiment the growing medium comprising at least 50% w/w plant-derived hydrogel comprises a plant-derived hydrogel comprising about 1% w/v methylcellulose, about 3.8% w/v kappa carrageenan and optionally about 1% w/v activated charcoal.

In one embodiment the growing medium comprises:
about 1% w/v methylcellulose;
about 3.8% w/v kappa carrageenan; and
optionally about 1% w/v activated charcoal;
made to volume with water.

In one embodiment the growing medium comprising at least 50% w/w plant-derived hydrogel comprises a plant-derived hydrogel comprising:
about 1% w/v methylcellulose;
about 3.8% w/v kappa carrageenan; and
optionally about 1% w/v activated charcoal;
made to volume with water.

In one embodiment the growing medium consists of:
about 1% w/v methylcellulose;
about 3.8% w/v kappa carrageenan; and
optionally about 1% w/v activated charcoal;
made to volume with water.

In one embodiment the growing medium comprising at least 50% w/w plant-derived hydrogel comprises a plant-derived hydrogel consisting of:
about 1% w/v methylcellulose;
about 3.8% w/v kappa carrageenan; and
optionally about 1% w/v activated charcoal;
made to volume with water.

In one embodiment the growing medium comprises 1-2% w/v methylcellulose, 1-2% w/v kappa carrageenan 0.25-0.75% w/v activated charcoal or biochar, and optionally 0.05-1.5% w/v lignin.

In one embodiment the growing medium comprises at least 50% w/w plant-derived hydrogel comprising 1-2% w/v methylcellulose, 1-2% w/v kappa carrageenan 0.25-0.75% w/v activated charcoal or biochar, and optionally 0.05-1.5% w/v lignin.

In one embodiment the growing medium comprises:
1-2% w/v methylcellulose;
1-2% w/v kappa carrageenan;
0.25-0.75% w/v activated charcoal or biochar; and
optionally 0.05-1.5% w/v lignin;
made to volume with water.

In one embodiment the growing medium comprises at least 50% w/w plant-derived hydrogel comprises a plant-derived hydrogel comprising:
1-2% w/v methylcellulose;
1-2% w/v kappa carrageenan;
0.25-0.75% w/v activated charcoal or biochar; and
optionally 0.05-1.5% w/v lignin;
made to volume with water.

In one embodiment the growing medium consists of:
1-2% w/v methylcellulose;
1-2% w/v kappa carrageenan;
0.25-0.75% w/v activated charcoal or biochar; and
optionally 0.05-1.5% w/v lignin;
made to volume with water.

In one embodiment the growing medium comprising at least 50% w/w plant-derived hydrogel comprises a plant-derived hydrogel consisting of:
1-2% w/v methylcellulose;
1-2% w/v kappa carrageenan;
0.25-0.75% w/v activated charcoal or biochar; and
optionally 0.05-1.5% w/v lignin;
made to volume with water.

In one embodiment the growing medium comprises 1.5% w/v methylcellulose, 1.5% w/v kappa carrageenan, 0.5% w/v activated charcoal or biochar, and optionally 0.1% w/v lignin.

In one embodiment the growing medium comprising at least 50% w/w plant-derived hydrogel comprises a plant-derived hydrogel comprising 1.5% w/v methylcellulose, 1.5% w/v kappa carrageenan, 0.5% w/v activated charcoal or biochar, and optionally 0.1% w/v lignin.

In one embodiment the growing medium comprises:
1.5% w/v methylcellulose;
1.5% w/v kappa carrageenan;
0.5% w/v activated charcoal or biochar; and
optionally 0.1% w/v lignin;
made to volume with water.

In one embodiment the growing medium comprising at least 50% w/w plant-derived hydrogel comprises a plant-derived hydrogel comprising:
1.5% w/v methylcellulose;
1.5% w/v kappa carrageenan;
0.5% w/v activated charcoal or biochar; and
optionally 0.1% w/v lignin;
made to volume with water.

In one embodiment the growing medium consists of:
1.5% w/v methylcellulose;
1.5% w/v kappa carrageenan;
0.5% w/v activated charcoal or biochar; and
optionally 0.1% w/v lignin;
made to volume with water.

In one embodiment the growing medium comprising at least 50% w/w plant-derived hydrogel comprises a plant-derived hydrogel consisting of:
1.5% w/v methylcellulose;
1.5% w/v kappa carrageenan;
0.5% w/v activated charcoal or biochar; and
optionally 0.1% w/v lignin;
made to volume with water.

In one embodiment the growing medium comprises about 1.5% w/v methylcellulose, about 1.5% w/v kappa carrageenan, about 0.5% w/v activated charcoal or biochar, and optionally about 0.1% w/v lignin.

In one embodiment the growing medium comprising at least 50% w/w plant-derived hydrogel comprises a plant-derived hydrogel comprising about 1.5% w/v methylcellulose, about 1.5% w/v kappa carrageenan, about 0.5% w/v activated charcoal or biochar, and optionally about 0.1% w/v lignin.

In one embodiment the growing medium comprises:
about 1.5% w/v methylcellulose;
about 1.5% w/v kappa carrageenan;
about 0.5% w/v activated charcoal or biochar; and
optionally about 0.1% w/v lignin;
made to volume with water.

In one embodiment the growing medium comprising at least 50% w/w plant-derived hydrogel comprises a plant-derived hydrogel comprising:
about 1.5% w/v methylcellulose;
about 1.5% w/v kappa carrageenan;
about 0.5% w/v activated charcoal or biochar; and
optionally about 0.1% w/v lignin;
made to volume with water.

In one embodiment the growing medium consists of:
about 1.5% w/v methylcellulose;
about 1.5% w/v kappa carrageenan;
about 0.5% w/v activated charcoal or biochar; and
optionally about 0.1% w/v lignin;
made to volume with water.

In one embodiment the growing medium comprising at least 50% w/w plant-derived hydrogel comprises a plant-derived hydrogel consisting of:
about 1.5% w/v methylcellulose;
about 1.5% w/v kappa carrageenan;
about 0.5% w/v activated charcoal or biochar; and
optionally about 0.1% w/v lignin;
made to volume with water.

In one embodiment the growing medium comprises 0.5-1.5% w/v methylcellulose, 0.5-1.5% w/v kappa carrageenan 0.25-0.75% w/v activated charcoal or biochar, and optionally 0.04-1% w/v sodium bicarbonate.

In one embodiment the growing medium comprises at least 50% w/w plant-derived hydrogel comprising 0.5-1.5% w/v methylcellulose, 0.5-1.5% w/v kappa carrageenan 0.25-0.75% w/v activated charcoal or biochar, and optionally 0.04-1% w/v sodium bicarbonate.

In one embodiment the growing medium comprises:
0.5-1.5% w/v methylcellulose;
0.5-1.5% w/v kappa carrageenan;
0.25-0.75% w/v activated charcoal or biochar; and
optionally 0.04-1% w/v sodium bicarbonate;
made to volume with water.

In one embodiment the growing medium comprises at least 50% w/w plant-derived hydrogel comprises a plant-derived hydrogel comprising:
0.5-1.5% w/v methylcellulose;
0.5-1.5% w/v kappa carrageenan;
0.25-0.75% w/v activated charcoal or biochar; and
optionally 0.04-1% w/v sodium bicarbonate;
made to volume with water.

In one embodiment the growing medium consists of:
0.5-1.5% w/v methylcellulose;
0.5-1.5% w/v kappa carrageenan;
0.25-0.75% w/v activated charcoal or biochar; and
optionally 0.04-1% w/v sodium bicarbonate;
made to volume with water.

In one embodiment the growing medium comprising at least 50% w/w plant-derived hydrogel comprises a plant-derived hydrogel consisting of:
0.5-1.5% w/v methylcellulose;
0.5-1.5% w/v kappa carrageenan;
0.25-0.75% w/v activated charcoal or biochar; and
optionally 0.04-1% w/v sodium bicarbonate;
made to volume with water.

In one embodiment the growing medium comprises 1% w/v methylcellulose, 1% w/v kappa carrageenan, 0.5% w/v activated charcoal or biochar, and optionally 0.07% w/v sodium bicarbonate.

In one embodiment the growing medium comprising at least 50% w/w plant-derived hydrogel comprises a plant-derived hydrogel comprising 1% w/v methylcellulose, 1% w/v kappa carrageenan, 0.5% w/v activated charcoal or biochar, and optionally 0.07% w/v sodium bicarbonate.

In one embodiment the growing medium comprises:
1% w/v methylcellulose;
1% w/v kappa carrageenan;
0.5% w/v activated charcoal or biochar; and
optionally 0.07% w/v sodium bicarbonate;
made to volume with water.

In one embodiment the growing medium comprising at least 50% w/w plant-derived hydrogel comprises a plant-derived hydrogel comprising:
1% w/v methylcellulose;
1% w/v kappa carrageenan;
0.5% w/v activated charcoal or biochar; and
optionally 0.07% w/v sodium bicarbonate;
made to volume with water.

In one embodiment the growing medium consists of:
1% w/v methylcellulose;
1% w/v kappa carrageenan;
0.5% w/v activated charcoal or biochar; and
optionally 0.07% w/v sodium bicarbonate;
made to volume with water.

In one embodiment the growing medium comprising at least 50% w/w plant-derived hydrogel comprises a plant-derived hydrogel consisting of:
1% w/v methylcellulose;
1% w/v kappa carrageenan;
0.5% w/v activated charcoal or biochar; and
optionally 0.07% w/v sodium bicarbonate;
made to volume with water.

In one embodiment the growing medium comprises about 1% w/v methylcellulose, about 1% w/v kappa carrageenan, about 0.5% w/v activated charcoal or biochar, and optionally about 0.07% w/v sodium bicarbonate.

In one embodiment the growing medium comprising at least 50% w/w plant-derived hydrogel comprises a plant-derived hydrogel comprising about 1% w/v methylcellulose, about 1% w/v kappa carrageenan, about 0.5% w/v activated charcoal or biochar, and optionally about 0.07% w/v sodium bicarbonate.

In one embodiment the growing medium comprises:
about 1% w/v methylcellulose;
about 1% w/v kappa carrageenan;
about 0.5% w/v activated charcoal or biochar; and
optionally about 0.07% w/v sodium bicarbonate;
made to volume with water.

In one embodiment the growing medium comprising at least 50% w/w plant-derived hydrogel comprises a plant-derived hydrogel comprising:
about 1% w/v methylcellulose;
about 1% w/v kappa carrageenan;
about 0.5% w/v activated charcoal or biochar; and
optionally about 0.07% w/v sodium bicarbonate;
made to volume with water.

In one embodiment the growing medium consists of:
about 1% w/v methylcellulose;
about 1% w/v kappa carrageenan;
about 0.5% w/v activated charcoal or biochar; and
optionally about 0.07% w/v sodium bicarbonate;
made to volume with water.

In one embodiment the growing medium comprising at least 50% w/w plant-derived hydrogel comprises a plant-derived hydrogel consisting of:
about 1% w/v methylcellulose;
about 1% w/v kappa carrageenan;
about 0.5% w/v activated charcoal or biochar; and
optionally about 0.07% w/v sodium bicarbonate;
made to volume with water.

In one embodiment the growing medium comprises 0.5-2% w/v methylcellulose, 1-3% w/v kappa carrageenan, 0.01-0.3% w/v activated charcoal or biochar, 0.01-0.1% w/v locust bean gum, and optionally 0.2-0.7% w/v salicylic acid.

In one embodiment the growing medium comprises at least 50% w/w plant-derived hydrogel comprising 0.5-2% w/v methylcellulose, 1-3% w/v kappa carrageenan, 0.01-0.3% w/v activated charcoal or biochar, 0.01-0.1% w/v locust bean gum, and optionally 0.2-0.7% w/v salicylic acid.

In one embodiment the growing medium comprises:
0.5-2% w/v methylcellulose;
1-3% w/v kappa carrageenan;
0.01-0.3% w/v activated charcoal or biochar;
0.01-0.1% w/v locust bean gum; and
optionally 0.2-0.7% w/v salicylic acid;
made to volume with water.

In one embodiment the growing medium comprises at least 50% w/w plant-derived hydrogel comprises a plant-derived hydrogel comprising:
0.5-2% w/v methylcellulose;
1-3% w/v kappa carrageenan;
0.01-0.3% w/v activated charcoal or biochar;
0.01-0.1% w/v locust bean gum; and
optionally 0.2-0.7% w/v salicylic acid;
made to volume with water.

In one embodiment the growing medium consists of:
0.5-2% w/v methylcellulose;
1-3% w/v kappa carrageenan;
0.01-0.3% w/v activated charcoal or biochar;
0.01-0.1% w/v locust bean gum; and
optionally 0.2-0.7% w/v salicylic acid;
made to volume with water.

In one embodiment the growing medium comprising at least 50% w/w plant-derived hydrogel comprises a plant-derived hydrogel consisting of:
0.5-2% w/v methylcellulose;
1-3% w/v kappa carrageenan;
0.01-0.3% w/v activated charcoal or biochar;
0.01-0.1% w/v locust bean gum; and
optionally 0.2-0.7% w/v salicylic acid;
made to volume with water.

In one embodiment the growing medium comprises 1% w/v methylcellulose, 2% w/v kappa carrageenan, 0.06% w/v activated charcoal or biochar, and 0.06% w/v locust bean gum.

In one embodiment the growing medium comprising at least 50% w/w plant-derived hydrogel comprises a plant-derived hydrogel comprising 1% w/v methylcellulose, 2% w/v kappa carrageenan, 0.06% w/v activated charcoal or biochar, and 0.06% w/v locust bean gum.

In one embodiment the growing medium comprises:
1% w/v methylcellulose;
2% w/v kappa carrageenan;
0.06% w/v activated charcoal or biochar; and
0.06% w/v locust bean gum;
made to volume with water.

In one embodiment the growing medium comprising at least 50% w/w plant-derived hydrogel comprises a plant-derived hydrogel comprising:
1% w/v methylcellulose;
2% w/v kappa carrageenan;
0.06% w/v activated charcoal or biochar; and
0.06% w/v locust bean gum;
made to volume with water.

In one embodiment the growing medium consists of:
1% w/v methylcellulose;
2% w/v kappa carrageenan;
0.06% w/v activated charcoal or biochar; and
0.06% w/v locust bean gum;
made to volume with water.

In one embodiment the growing medium comprising at least 50% w/w plant-derived hydrogel comprises a plant-derived hydrogel consisting of:
1% w/v methylcellulose;
2% w/v kappa carrageenan;
0.06% w/v activated charcoal or biochar; and
0.06% w/v locust bean gum;
made to volume with water.

In one embodiment the growing medium comprises about 1% w/v methylcellulose, about 2% w/v kappa carrageenan, about 0.06% w/v activated charcoal or biochar, and about 0.06% w/v locust bean gum.

In one embodiment the growing medium comprising at least 50% w/w plant-derived hydrogel comprises a plant-derived hydrogel comprising about 1% w/v methylcellulose, about 2% w/v kappa carrageenan, about 0.06% w/v activated charcoal or biochar, and about 0.06% w/v locust bean gum.

In one embodiment the growing medium comprises:
about 1% w/v methylcellulose;
about 2% w/v kappa carrageenan;
about 0.06% w/v activated charcoal or biochar; and
about 0.06% w/v locust bean gum;
made to volume with water.

In one embodiment the growing medium comprising at least 50% w/w plant-derived hydrogel comprises a plant-derived hydrogel comprising:
about 1% w/v methylcellulose;
about 2% w/v kappa carrageenan;
about 0.06% w/v activated charcoal or biochar; and
about 0.06% w/v locust bean gum;
made to volume with water.

In one embodiment the growing medium consists of:
about 1% w/v methylcellulose;
about 2% w/v kappa carrageenan;
about 0.06% w/v activated charcoal or biochar; and
about 0.06% w/v locust bean gum;
made to volume with water.

In one embodiment the growing medium comprising at least 50% w/w plant-derived hydrogel comprises a plant-derived hydrogel consisting of:
about 1% w/v methylcellulose;
about 2% w/v kappa carrageenan;
about 0.06% w/v activated charcoal or biochar; and
about 0.06% w/v locust bean gum;
made to volume with water.

In one embodiment the growing medium comprises 1% w/v methylcellulose, 2% w/v kappa carrageenan, 0.2% w/v activated charcoal or biochar, 0.06% w/v locust bean gum and optionally 0.44% w/v salicylic acid.

In one embodiment the growing medium comprising at least 50% w/w plant-derived hydrogel comprises a plant-derived hydrogel comprising 1% w/v methylcellulose, 2% w/v kappa carrageenan, 0.2% w/v activated charcoal or biochar, 0.06% w/v locust bean gum and optionally 0.44% w/v salicylic acid.

In one embodiment the growing medium comprises:
1% w/v methylcellulose;
2% w/v kappa carrageenan;
0.2% w/v activated charcoal or biochar;
0.06% w/v locust bean gum; and
and optionally 0.44% w/v salicylic acid;
made to volume with water.

In one embodiment the growing medium comprising at least 50% w/w plant-derived hydrogel comprises a plant-derived hydrogel comprising:
1% w/v methylcellulose;
2% w/v kappa carrageenan;
0.2% w/v activated charcoal or biochar;
0.06% w/v locust bean gum; and
and optionally 0.44% w/v salicylic acid;
made to volume with water.

In one embodiment the growing medium consists of:
1% w/v methylcellulose;
2% w/v kappa carrageenan;
0.2% w/v activated charcoal or biochar;
0.06% w/v locust bean gum; and
and optionally 0.44% w/v salicylic acid;
made to volume with water.

In one embodiment the growing medium comprising at least 50% w/w plant-derived hydrogel comprises a plant-derived hydrogel consisting of:
1% w/v methylcellulose;
2% w/v kappa carrageenan;
0.2% w/v activated charcoal or biochar;
0.06% w/v locust bean gum; and
and optionally 0.44% w/v salicylic acid;
made to volume with water.

In one embodiment the growing medium comprises about 1% w/v methylcellulose, about 2% w/v kappa carrageenan, about 0.2% w/v activated charcoal or biochar, about 0.06% w/v locust bean gum, and optionally about 0.44% w/v salicylic acid.

In one embodiment the growing medium comprising at least 50% w/w plant-derived hydrogel comprises a plant-derived hydrogel comprising about 1% w/v methylcellulose, about 2% w/v kappa carrageenan, about 0.2% w/v activated charcoal or biochar, about 0.06% w/v locust bean gum and optionally about 0.44% w/v salicylic acid.

In one embodiment the growing medium comprises:
about 1% w/v methylcellulose;
about 2% w/v kappa carrageenan;
about 0.2% w/v activated charcoal or biochar;
about 0.06% w/v locust bean gum; and
and optionally about 0.44% w/v salicylic acid;
made to volume with water.

In one embodiment the growing medium comprising at least 50% w/w plant-derived hydrogel comprises a plant-derived hydrogel comprising:
about 1% w/v methylcellulose;
about 2% w/v kappa carrageenan;
about 0.2% w/v activated charcoal or biochar; and
about 0.06% w/v locust bean gum;
and optionally about 0.44% w/v salicylic acid;
made to volume with water.

In one embodiment the growing medium consists of:
about 1% w/v methylcellulose;
about 2% w/v kappa carrageenan;
about 0.2% w/v activated charcoal or biochar; and
about 0.06% w/v locust bean gum;
and optionally about 0.44% w/v salicylic acid;
made to volume with water.

In one embodiment the growing medium comprising at least 50% w/w plant-derived hydrogel comprises a plant-derived hydrogel consisting of:
about 1% w/v methylcellulose;
about 2% w/v kappa carrageenan;
about 0.2% w/v activated charcoal or biochar; and
about 0.06% w/v locust bean gum;
and optionally about 0.44% w/v salicylic acid;
made to volume with water.

In one embodiment the growing medium comprises 0.2-0.7% w/v methylcellulose, 1-3% w/v kappa carrageenan, 0.05-0.35% w/v activated charcoal, 0.2-0.6% w/v guar gum or xanthan gum, 0.05-1.5% w/v ammonium bicarbonate and 0.05-1.5% w/v potassium bitartrate.

In one embodiment the growing medium comprises at least 50% w/w plant-derived hydrogel comprising 0.2-0.7% w/v methylcellulose, 1-3% w/v kappa carrageenan, 0.05-0.35% w/v activated charcoal, 0.2-0.6% w/v guar gum or xanthan gum, 0.05-1.5% w/v ammonium bicarbonate and 0.05-1.5% w/v potassium bitartrate.

In one embodiment the growing medium comprises:
0.2-0.7% w/v methylcellulose;
1-3% w/v kappa carrageenan;
0.05-0.35% w/v activated charcoal;
0.2-0.6% w/v guar gum or xanthan gum;
0.05-1.5% w/v ammonium bicarbonate; and
0.05-1.5% w/v potassium bitartrate made to volume with water.

In one embodiment the growing medium comprises at least 50% w/w plant-derived hydrogel comprises a plant-derived hydrogel comprising:
0.2-0.7% w/v methylcellulose;
1-3% w/v kappa carrageenan;
0.05-0.35% w/v activated charcoal;
0.2-0.6% w/v guar gum or xanthan gum;
0.05-1.5% w/v ammonium bicarbonate; and
0.05-1.5% w/v potassium bitartrate made to volume with water.
made to volume with water.

In one embodiment the growing medium consists of:
0.2-0.7% w/v methylcellulose;
1-3% w/v kappa carrageenan;
0.05-0.35% w/v activated charcoal;
0.2-0.6% w/v guar gum or xanthan gum;
0.05-1.5% w/v ammonium bicarbonate; and
0.05-1.5% w/v potassium bitartrate made to volume with water.
made to volume with water.

In one embodiment the growing medium comprising at least 50% w/w plant-derived hydrogel comprises a plant-derived hydrogel consisting of:
0.2-0.7% w/v methylcellulose;
1-3% w/v kappa carrageenan;
0.05-0.35% w/v activated charcoal;
0.2-0.6% w/v guar gum or xanthan gum;
0.05-1.5% w/v ammonium bicarbonate; and
0.05-1.5% w/v potassium bitartrate made to volume with water.
made to volume with water.

In one embodiment the growing medium comprises 0.4% w/v methylcellulose, 2% w/v kappa carrageenan, 0.2% w/v activated charcoal, 0.4% w/v guar gum or xanthan gum, 0.1% w/v ammonium bicarbonate and 0.1% w/v potassium bitartrate.

In one embodiment the growing medium comprising at least 50% w/w plant-derived hydrogel comprises a plant-derived hydrogel comprising 0.4% w/v methylcellulose, 2% w/v kappa carrageenan, 0.2% w/v activated charcoal, 0.4% w/v guar gum or xanthan gum, 0.1% w/v ammonium bicarbonate and 0.1% w/v potassium bitartrate.

In one embodiment the growing medium comprises:
0.4% w/v methylcellulose;
2% w/v kappa carrageenan;
0.2% w/v activated charcoal;
0.4% w/v guar gum or xanthan gum;
0.1% w/v ammonium bicarbonate; and
0.1% w/v potassium bitartrate;
made to volume with water.

In one embodiment the growing medium comprising at least 50% w/w plant-derived hydrogel comprises a plant-derived hydrogel comprising:
0.4% w/v methylcellulose;
2% w/v kappa carrageenan;
0.2% w/v activated charcoal;
0.4% w/v guar gum or xanthan gum;
0.1% w/v ammonium bicarbonate; and
0.1% w/v potassium bitartrate;
made to volume with water.

In one embodiment the growing medium consists of:
0.4% w/v methylcellulose;
2% w/v kappa carrageenan;
0.2% w/v activated charcoal;
0.4% w/v guar gum or xanthan gum;
0.1% w/v ammonium bicarbonate; and
0.1% w/v potassium bitartrate;
made to volume with water.

In one embodiment the growing medium comprising at least 50% w/w plant-derived hydrogel comprises a plant-derived hydrogel consisting of:
0.4% w/v methylcellulose;
2% w/v kappa carrageenan;
0.2% w/v activated charcoal;
0.4% w/v guar gum or xanthan gum;
0.1% w/v ammonium bicarbonate; and
0.1% w/v potassium bitartrate;
made to volume with water.

In one embodiment the growing medium comprises about 0.4% w/v methylcellulose, about 2% w/v kappa carrageenan, about 0.2% w/v activated charcoal, about 0.4% w/v guar gum or xanthan gum, about 0.1% w/v ammonium bicarbonate and about 0.1% w/v potassium bitartrate.

In one embodiment the growing medium comprising at least 50% w/w plant-derived hydrogel comprises a plant-derived hydrogel comprising about 0.4% w/v methylcellulose, about 2% w/v kappa carrageenan, about 0.2% w/v activated charcoal, about 0.4% w/v guar gum or xanthan gum, about 0.1% w/v ammonium bicarbonate and about 0.1% w/v potassium bitartrate.

In one embodiment the growing medium comprises:
about 0.4% w/v methylcellulose;
about 2% w/v kappa carrageenan;
about 0.2% w/v activated charcoal;
about 0.4% w/v guar gum or xanthan gum;
about 0.1% w/v ammonium bicarbonate; and
about 0.1% w/v potassium bitartrate made to volume with water.

In one embodiment the growing medium comprising at least 50% w/w plant-derived hydrogel comprises a plant-derived hydrogel comprising:
about 0.4% w/v methylcellulose;
about 2% w/v kappa carrageenan;
about 0.2% w/v activated charcoal;
about 0.4% w/v guar gum or xanthan gum;
about 0.1% w/v ammonium bicarbonate; and
about 0.1% w/v potassium bitartrate made to volume with water.

In one embodiment the growing medium consists of:
about 0.4% w/v methylcellulose;
about 2% w/v kappa carrageenan;
about 0.2% w/v activated charcoal;
about 0.4% w/v guar gum or xanthan gum;
about 0.1% w/v ammonium bicarbonate; and
about 0.1% w/v potassium bitartrate made to volume with water.

In one embodiment the growing medium comprising at least 50% w/w plant-derived hydrogel comprises a plant-derived hydrogel consisting of:
about 0.4% w/v methylcellulose;
about 2% w/v kappa carrageenan;
about 0.2% w/v activated charcoal;
about 0.4% w/v guar gum or xanthan gum;
about 0.1% w/v ammonium bicarbonate; and
about 0.1% w/v potassium bitartrate made to volume with water.

In one embodiment where water is referred to, some or all of the water may be carbonated or “sparkling” water. Using carbonated water may assist in making the hydrogel more porous.

### Processes

The growing media described herein may be produced by adding the constituent ingredients to water, e.g. water at 55° C., under stirring; stirred at a suitable speed for a suitable time, e.g. 10 minutes at speed of 1500 RPM; and then poured into the desired shaped mould and left to set. The growing media generally set in 5 mins at 4° C. or in about 30 mins at room temperature.

Sheets may be prepared by pouring the growing media into a tray, for example a polystyrene or any non-adhesive surface tray. To prepare plugs the growing media may be poured into suitable moulds.

In one embodiment the growing medium may be supplied in dehydrated form, for example dehydrated sheets, dehydrated plugs, and/or powder, flake or granule form, optionally with instructions for rehydration and use. “Dehydrated form” means at least 50% of the water w/w has been removed from the growing medium.

In one embodiment “dehydrated form” means at least 60% water w/w has been removed from the growing medium.

In one embodiment “dehydrated form” means at least 70% water w/w has been removed from the growing medium.

In one embodiment “dehydrated form” means at least 80% water w/w has been removed from the growing medium.

In one embodiment “dehydrated form” means at least 90% water w/w has been removed from the growing medium.

In one embodiment “dehydrated form” means at least 92% water w/w has been removed from the growing medium.

In one embodiment “dehydrated form” means at least 95% water w/w has been removed from the growing medium.

In one embodiment “dehydrated form” means at least 98% water w/w has been removed from the growing medium.

In one embodiment “dehydrated form” means all water w/w has been removed from the growing medium.

Hydrogels in sheet form, for example, may be left in a drying oven at 45° C. for 24-36 hours to dehydrate. In one embodiment hydrogels in dehydrated sheet form may be compressed. Suitably, uncompressed sheets may have a thickness of 0.7-0.9 cm, after the compression the thickness may be 0.1 cm-0.4 cm. To form powders, flakes or granules, dehydrated hydrogels may be ground/processed into different sizes (0.1 mm-5 cm), particularly a range of different sizes.

In one embodiment the growing medium in dehydrated form may be supplied in sachet, optionally with instructions for rehydration and use.

In a further embodiment the growing medium in dehydrated form may be supplied together with the seeds, optionally with instructions for rehydration and use.

In one embodiment the growing medium may be employed in trays.

In one embodiment the growing medium may be employed in pots.

In one embodiment there is provided a process for preparing a growing medium as described herein which comprises mixing one or more plant-derived super absorbent polymers with water and allowing to set.

In one embodiment there is provided a process for preparing a growing medium as described herein which comprises mixing one or more plant-derived super absorbent polymers selected from cellulose or a derivative thereof, starch, soy, plant protein, lignin, pectin, carrageenan, and/or gum, with water and allowing to set.

In one embodiment there is provided a process for preparing a growing medium as described herein which comprises mixing methyl cellulose, xanthan gum, kappa carrageenan, sodium carboxymethyl cellulose and/or carboxymethyl cellulose, with water and allowing to set.

In one embodiment there is provided a process for preparing a growing medium as described herein which comprises mixing methyl cellulose, xanthan gum, guar gum, locust bean gum, kappa carrageenan, sodium carboxymethyl cellulose and/or carboxymethyl cellulose, with water and allowing to set.

In one embodiment there is provided a process for preparing a growing medium as described herein which comprises mixing methyl cellulose and kappa carrageenan with water and allowing to set.

In one embodiment there is provided a process for preparing a growing medium as described herein which comprises mixing one or more plant-derived super absorbent polymers, optionally with one or more additional ingredients, with water and allowing to set.

In one embodiment there is provided a process for preparing a growing medium as described herein which comprises mixing one or more plant-derived super absorbent polymers selected from cellulose or a derivative thereof, starch, soy, plant protein, lignin, pectin, carrageenan, and/or gum, optionally with one or more additional ingredients selected from biochar, Psyllium, chitosan, barley seed powder, graphene, graphene oxide, reduced graphene oxide, agar, silk fibroin, genipin, honey, coconut oil, tea tree oil, charcoal, activated charcoal, vanillin, glycerol, clays, jute fibre and/or cotton, with water and allowing to set.

In one embodiment there is provided a process for preparing a growing medium as described herein which comprises mixing one or more plant-derived super absorbent polymers selected from cellulose or a derivative thereof, starch, soy, plant protein, lignin, pectin, carrageenan, and/or gum, optionally with one or more additional ingredients selected from biochar, Psyllium, chitosan, barley seed powder, graphene, graphene oxide, reduced graphene oxide, agar, silk fibroin, genipin, honey, coconut oil, tea tree oil, charcoal, activated charcoal, vanillin, glycerol, clays, jute fibre, cotton, salicylic acid, sulfo salicylic acid, ammonium bicarbonate and/or potassium bitartrate, with water and allowing to set.

In one embodiment there is provided a process for preparing a growing medium as described herein which comprises mixing methyl cellulose, xanthan gum, kappa carrageenan, sodium carboxymethyl cellulose and/or carboxymethyl cellulose, optionally with one or more additional ingredients selected from biochar, Psyllium, chitosan, barley seed powder, graphene, graphene oxide, reduced graphene oxide, agar, silk fibroin, genipin, honey, coconut oil, tea tree oil, charcoal, activated charcoal, vanillin, glycerol, clays, jute fibre and/or cotton, with water and allowing to set.

In one embodiment there is provided a process for preparing a growing medium as described herein which comprises mixing methyl cellulose, xanthan gum, guar gum, locust bean gum, kappa carrageenan, sodium carboxymethyl cellulose or carboxymethyl cellulose, optionally with one or more additional ingredients selected from biochar, Psyllium, chitosan, barley seed powder, graphene, graphene oxide, reduced graphene oxide, agar, silk fibroin, genipin, honey, coconut oil, tea tree oil, charcoal, activated charcoal, vanillin, glycerol, clays, jute fibre, cotton, salicylic acid, sulfo salicylic acid, ammonium bicarbonate and/or potassium bitartrate, with water and allowing to set.

In one embodiment there is provided a process for preparing a growing medium as described herein which comprises mixing methyl cellulose and kappa carrageenan optionally with one or more additional ingredients selected from biochar, Psyllium, chitosan, barley seed powder, graphene, graphene oxide, reduced graphene oxide, agar, silk fibroin, genipin, honey, coconut oil, tea tree oil, charcoal, activated charcoal, vanillin, glycerol, clays, jute fibre and/or cotton, with water and allowing to set.

In one embodiment there is provided a process for preparing a growing medium as described herein which comprises mixing methyl cellulose and kappa carrageenan optionally with one or more additional ingredients selected from biochar, Psyllium, chitosan, barley seed powder, graphene, graphene oxide, reduced graphene oxide, agar, silk fibroin, genipin, honey, coconut oil, tea tree oil, charcoal, activated charcoal, vanillin, glycerol, clays, jute fibre, cotton, salicylic acid, sulfo salicylic acid, ammonium bicarbonate and/or potassium bitartrate, with water and allowing to set.

In one embodiment there is provided a process for preparing a growing medium as described herein which comprises mixing methyl cellulose, kappa carrageenan, and biochar, with water and allowing to set.

In one embodiment there is provided a process for preparing a growing medium as described herein which comprises mixing methyl cellulose and kappa carrageenan with water and allowing to set.

### Uses

The growing media described herein can be employed in a wide variety of indoor farming situations, including greenhouse and vertical farming.

In one embodiment there is provided the use of a growing medium as described herein in agriculture.

In one embodiment there is provided the use of a growing medium as described herein in vertical farming.

In one embodiment there is provided the use of a growing medium as described herein in germinating seeds.

In one embodiment there is provided the use of a growing medium as described herein in growing plants.

In one embodiment there is provided the use of a growing medium as described herein in growing plants from seed.

In one embodiment there is provided the use of a growing medium as described herein in growing leafy greens, strawberries, tomatoes or vine crops.

In one embodiment there is provided the use of a growing medium as described herein in growing leafy greens, strawberries, tomatoes or vine crops from seed.

### Kits

In one embodiment there is provided a kit comprising:
i) a growing medium as described herein; and optionally
ii) instructions for use.

In one embodiment there is provided a kit comprising:
i) a growing medium as described herein in dehydrated form; and optionally
ii) seeds; and optionally
ii) instructions for use.

In one embodiment there is provided a kit comprising:
i) a growing medium in powder form as described herein; and optionally
ii) instructions for use.

In one embodiment there is provided a kit comprising:
i) a growing medium as described herein in dehydrated powder form; and optionally
ii) seeds; and optionally
ii) instructions for use.

In one embodiment there is provided a kit comprising:
i) a growing medium in granule form as described herein; and optionally
ii) instructions for use.

In one embodiment there is provided a kit comprising:
i) a growing medium as described herein in dehydrated granule form; and optionally
ii) seeds; and optionally
ii) instructions for use.

In one embodiment there is provided a kit comprising:
i) a growing medium in flake form as described herein; and optionally
ii) instructions for use.

In one embodiment there is provided a kit comprising:
i) a growing medium as described herein in dehydrated flake form; and optionally
ii) seeds; and optionally
ii) instructions for use.

In one embodiment there is provided a kit comprising:
i) a growing medium in granule and flake form as described herein; and optionally
ii) instructions for use.

In one embodiment there is provided a kit comprising:
i) a growing medium as described herein in dehydrated granule and flake form; and optionally
ii) seeds; and optionally
ii) instructions for use.

In one embodiment there is provided a kit comprising:
i) a growing medium in sheet form as described herein; and optionally
ii) instructions for use.

In one embodiment there is provided a kit comprising:
i) a growing medium as described herein in dehydrated sheet form; and optionally
ii) seeds; and optionally
ii) instructions for use.

In one embodiment there is provided a kit comprising:
i) a growing medium in plug form as described herein; and optionally
ii) instructions for use.

In one embodiment there is provided a kit comprising:
i) a growing medium as described herein in dehydrated plug form; and optionally
ii) seeds; and optionally
ii) instructions for use.

### BRIEF DESCRIPTION OF THE FIGURES

FIG. 1 shows the results from Experiment 7, copacabana lettuce growth. In each pair of photos, the first photo is Day 1 (post seed germination) and the second photo is the mature plants after they have grown under the experimental conditions for a further 28 days.

FIG. 2 shows the results from Experiment 7, sweet genovese basil growth. In each pair of photos, the first photo is Day 1 (post seed germination) and the second photo is the mature plants after they have grown under the experimental conditions for a further 34 days.

FIG. 3 shows the results from Experiment 7, helios spinach growth. In each pair of photos, the first photo is Day 1 (post seed germination) and the second photo is the mature plants after they have grown under the experimental conditions for a further 28 days.

FIG. 4 shows a table of the examples prepared by the procedure of Experiment 2.

### EXAMPLES

### Materials

The following compounds were used in the experiments:
Sodium Alginate (NaAlg): high quality premium grade, halal, vegan; Sigma Aldrich®
Methyl cellulose (MC): food grade, vegan, non-GMO, gluten free, Intralabs®
Sodium carboxymethyl cellulose (NaCMC): High quality grade and food grade; Sigma Aldrich® and Intralabs®
Biochar (BC): Industrial grade, Greenfield Eco solutions Ltd®
Xanthan Gum (XG): suitable for vegans, non-GMO, gluten free, Naturevibe Botanicals Store®
Pectin: highest quality food grade pectin powder, vegetarian, vegan and also halal/kosher friendly, Intra Labs®
Kappa Carrageenan (KC): Gelling Agent Vegan Vegetarian Alternative to Gelatine Halal Kosher Gluten Free, Mr.P Ingredients Store®
Glycerol: Sigma Aldrich®
Lignin: Sigma Aldrich®
Clay Particles (CP): Nanoclay, hydrophilic bentonite, Sigma Aldrich®
Activated Charcoal: HNCO Organics Private Limited®
Locus bean gum: Speciality Ingredients®
Sodium Bicarbonate: FunCakes®
Salicylic acid: Sigma Aldrich®
Guar gum: Speciality Ingredients®
Ammonium bicarbonate: FunCakes®
Cream of tartar: Speciality Ingredients®

### Experiment 1: Preparation of Hydrogel Compositions

### General Preparation

The water in a beaker was put under a mixer and turned on. The components of the hydrogel in powder form were weighed and added to water under continuous stirring. The solution was mixed for 10 minutes at speed of 1500 RPM to obtain homogenous mixing.

### Example 1

The components (methyl cellulose 3% w/v, xanthan gum 1% w/v, biochar 0.5% w/v) in powder form were weighed. Water at a temperature of 55° C. was added to a container and put under the mixer. The mixer (beater/whisker type) was turned ON and the weighed components were added to the hot water under continuous stirring. The solution was mixed for 10 minutes at speed of 1500 RPM for homogenous mixing and preparation of the gel.

The following hydrogels were prepared in a manner analogous to the above.

| Example No | Composition (% w/v) |
|---|---|
| 2 | 3% MC |
| 3 | 3% MC; 1% XG |
| 4 | 3% MC; 0.5% BC |
| 5 | 3% XG; 1% MC |
| 6 | 3% XG |
| 7 | 3% XG; 0.1% BC |
| 8 | 2% XG; 1% NaAlg |
| 9 | 4% NaAlg; 1% XG |
| 10 | 3% MC; 1% NaAlg |
| 11 | 3% MC; 2% NaAlg |
| 12 | 3% MC; 3% NaAlg |
| 13 | 3% MC; 4% NaAlg |
| 14 | 3% XG; 1% NaAlg |
| 15 | 3% XG; 2% NaAlg |
| 16 | 3% XG; 3% NaAlg |
| 17 | 3% XG; 4% NaAlg |
| 18 | 3% MC; 2% XG |
| 19 | 3% MC; 3% XG |
| 20 | 3% MC; 4% XG |
| 21 | 5% XG |
| 22 | 3% MC; 0.25% KC |
| 23 | 3% MC; 0.5% KC |
| 24 | 1.5% KC |
| 25 | 2% KC |
| 26 | 3% KC |
| 27 | 1% KC; 1% XG |
| 28 | 1% KC; 2% XG |
| 29 | 1% KC; 3% XG |
| 30 | 2% CP; 3% XG |
| 31 | 0.5% CP; 3% XG |
| 32 | 1% CP; 3% XG |
| 33 | 0.01% CP; 3% XG |
| 34 | 0.02% CP; 3% XG |
| 35 | 2.9% MC; 0.1% KC |
| 36 | 2% KC; 1% MC |
| 37 | 2% MC; 1% KC |
| 38 | 1% MC; 1% XG; 1% KC |
| 39 | 2% MC; 1% XG; 1% KC |
| 40 | 2% MC; 1% XG; 0.5% KC |
| 41 | 2% MC; 0.5% XG; 0.5% KC |
| 42 | 2% MC; 0.5% XG; 1% KC |
| 43 | 1% MC; 1% XG; 2% KC |
| 44 | 0.5% MC; 1% XG; 2% KC |
| 45 | 0.5% MC; 2% XG; 0.5% KC |
| 46 | 0.5% MC; 2% XG; 1% KC |
| 47 | 1.9% MC; 1.1% KC |
| 48 | 1.8% MC; 1.2% KC |
| 49 | 1.7% MC; 1.3% KC |
| 50 | 1.6% MC; 1.4% KC |
| 51 | 1.5% MC; 1.5% KC |
| 52 | 1.4% MC; 1.6% KC |
| 53 | 1.3% MC; 1.7% KC |
| 54 | 1.3% MC; 1.8% KC |
| 55 | 1.1% MC; 1.9% KC |
| 56 | 1.5% MC; 1.5% KC; 0.5% BC |
| 57 | 1.6% MC; 1.4% KC; 0.5% BC |
| 58 | 2% MC; 1% KC; 0.5% BC |
| 59 | 2% MC; 1% XG; 1% KC; 0.5% BC |
| 60 | 3% MC; 4% XG; 0.5% BC |
| 61 | 1% KC |
| 62 | 1.1% KC |
| 63 | 1.2% KC |
| 64 | 1.3% KC |
| 65 | 1.4% KC |
| 66 | 1.5% MC; 1% KC; 0.5% BC |
| 67 | 1.5% MC; 1.5% KC; 0.25% BC |
| 68 | 1% MC; 1.5% KC; 0.5% BC |
| 69 | 1.5% XG; 1.5% KC |
| 70 | 0.1% KC; 0.5% Glycerol |
| 71 | 1% KC; 2% MC; 0.5% Glycerol |
| 72 | 0.8% KC; 2.2% MC; 0.5% Glycerol |
| 73 | 3% NaCMC |
| 74 | 1% KC; 2% NaCMC |
| 75 | 2% NaCMC; 1% KC |
| 76 | 2% KC; 1% NaCMC |
| 77 | 3% NaCMC; 1% CP |
| 78 | 3% NaCMC; 2% CP |
| 79 | 3% NaCMC; 3% CP |
| 80 | 1.1% NaCMC; 1.9% KC |
| 81 | 1.2% NaCMC; 1.8% KC |
| 82 | 1.3% NaCMC; 1.7% KC |
| 83 | 1.4% NaCMC; 1.6% KC |
| 84 | 1.5% NaCMC; 1.5% KC |
| 85 | 1.6% NaCMC; 1.4% KC |
| 86 | 1.7% NaCMC; 1.3% KC |
| 87 | 1.6% NaCMC; 1.4% KC |
| 88 | 1.8% NaCMC; 1.2% KC |
| 89 | 1.9% NaCMC; 1% KC |
| 90 | 1.9% NaCMC; 2% KC |
| 91 | 1.9% NaCMC; 3% KC |
| 92 | 1.9% NaCMC; 4% KC |
| 93 | 1.9% NaCMC; 5% KC |
| 94 | 1.9% NaCMC; 1% KC; % MC |
| 95 | 1.9% NaCMC; 1% KC; 2% MC |
| 96 | 1.9% NaCMC; 1% KC; 3% MC |
| 97 | 1.9% NaCMC; 1% KC; 4% MC |
| 98 | 1.9% NaCMC; 1% KC; 5% MC |
| 99 | 1.8% NaCMC; 1% KC; 1% MC; 0.1 XG |
| 100 | 1.8% NaCMC; 1% KC; 1% MC; 0.2% XG |
| 101 | 1.4% KC; 0.1% MC |
| 102 | 1.3% KC; 0.2% MC |
| 103 | 1.2% KC; 0.3% MC |
| 104 | 1.4% KC; 0.1% XG |
| 105 | 1.3% KC; 0.2% XG |
| 106 | 1.2% KC; 0.3% XG |
| 107 | 2% MC; 1% Pectin |
| 108 | 2% KC; 1% Pectin |
| 109 | 2% MC; 1% KC; 0.5% Pectin |
| 110 | 1% MC; 2% KC; 0.5% Pectin |
| 111 | 1% MC; 1% KC; 1% Lignin; 0.5% Pectin |
| 112 | 1% MC; 1% KC; 1% Pectin |
| 113 | 1% MC; 1% Lignin; 1% Pectin |
| 114 | 1% KC; 3% Lignin; 2% Pectin |
| 115 | 3% MC; 3% Lignin; 2% Pectin |
| 116 | 1.2% KC; 0.3% MC; 0.25% BC |
| 117 | 1.5% KC; 1% BC; 1% MC |
| 118 | 1% BC; 1% MC; 1.33% KC |

### Experiment 2: Alternative Preparation of Hydrogel Compositions

The components of the hydrogel in powder form were weighed and added to 200 ml boiling water under low speed continuous stirring. The speed of the mixer was then increased to high speed and after 3 mins of stirring 200 ml of 54° C. water was added. After 5 further minutes of mixing, 100 ml of boiling water was added and the mixture was stirred for a further 2 minutes to obtain a homogenous mixture.

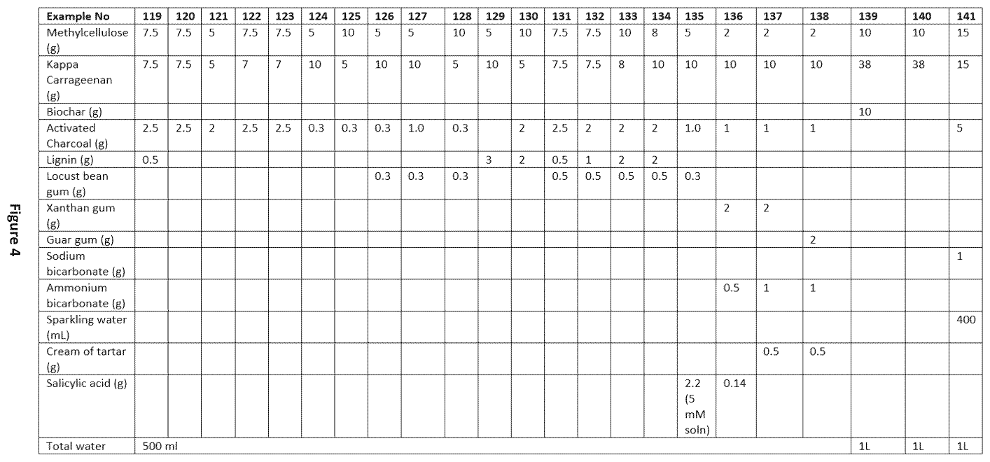

A table of the examples prepared by this procedure is shown in FIG. 4. Where the total volume of water is 11 in FIG. 4, the water in the procedure above was doubled.

### Experiment 3: Preparation of Shapes

The hydrogels described herein can be manufactured in different format, for example granules, sheets of different thicknesses, and blocks. They may be first left to set, and then dehydrated for ease of supply.

### i) Sheets

To form sheets, gels prepared by the above procedure may be poured onto polystyrene trays and allowed to set. Sheets in dehydrated form may be prepared by placing the trays in a drying oven. A drying oven with a temperature controller may be used to provide uniform heat to the gels. Most gels uniformly dehydrate at 25-60° C. with good integrity and structure.

Alternatively, a vacuum oven drying (dehydrating) technique may be used to maintain a porous structure of the gels and prepare uniform sheets in dehydrated form. The vacuum helps to swell the gels and enhance the porosity within the sheet structure.

Other techniques that may be used to dehydrate gels in sheet form are freeze drying, microwave oven drying and air drying.

### EXAMPLE

Example 58 was prepared by mixing the constituent ingredients for 10 minutes at a speed of 1200 RPM. The prepared gel was poured on to a polystyrene tray and then dehydrated in the drying oven at 45° C. for 24-36 hours.

The following sheets in dehydrated form were prepared by the above technique:

| Sheet Number | Hydrogel | Weight before dehydration | Weight after dehydration |
|---|---|---|---|
| SH 36 | Example 36 | 21 g | 1 g |
| SH 56 | Example 56 | 18 g | 1 g |
| SH 58 | Example 58 | 18 g | 1 g |
| SH 59 | Example 59 | 20 g | 1 g |
| SH 67 | Example 67 | 21 g | 1 g |
| SH 103 | Example 103 | 19 g | 1 g |

### ii) Cubes/Blocks

To form cubes or blocks, gels prepared by the above procedure may be poured into a hydrophobic mold and allowed to set for 15 minutes. After the solidification of the gels, they were cut into the shapes of cubes to form blocks.

### EXAMPLE

Example 56 was prepared by the above procedure by mixing for 10 minutes at speed of 1200 RPM. The gel was poured on to a tray with hydrophobic surface (e.g. polystyrene) and left to set at 25° C. for 30 minutes. Once the gels were set, they were cut in shape of cubes to form blocks which were dehydrated in an oven at 45° C.

iii) Flakes

To form flakes, prepared gels may be air dehydrated and processed into flake form via a grinding machine.

### iv) Granules Procedure

To form granules, prepared gels may be air dehydrated and crushed into granules via a grinding machine.

### Experiment 4: Rewetability

Prior to use in agriculture, dehydrated gel-based products prepared as per the above need to be rewetted with water. Different sheets, for example, have different rewetting rates depending on their composition, and some crops may benefit from a longer sheet rewetting time. For example SH 36 can be rewetted and ready to sow seeds in 4 minutes and SH 56 can be rewetted for use in 8 minutes. However, it may be beneficial for some crops for SH 56, SH 58, SH 59, SH 67 and SH 103 to be rewetted for about 10 minutes. Of these gels, SH 103 and SH 36 can absorb the maximum quantity of water i.e., around 19 g/g (i.e. 19 g of water per 1 g of dehydrated gel).

| | Initial dehydrated | | |
|---|---|---|---|
| Gel (sheet) | weight (g) | Soaking time | Rewetted weight |
| SH 36 | 1 g | 4 mins | 20 g |
| SH 56 | 1 g | 8 mins | 13 g |
| SH 58 | 1 g | 8 mins | 8 g |
| SH 59 | 1 g | 8 mins | 7.9 g |
| SH 67 | 1 g | 8 mins | 19 g |
| SH 103 | 1 g | 8 mins | 12 g |

### Experiment 5: Germination

After rewetting the sheets, seeds were sown on them, and germination percentage was recorded after 5 days (room temperature, humidity 65%, dark).

| Seed type | Gel type (sheet) | % Germination |
|---|---|---|
| Spinach Freja | SH 36 | 100 |
| Spinach Freja | SH 59 | 100 |
| Spinach Freja | SH 67 | 82 |
| Spinach Helios | SH 58 | 100 |
| Basil | SH 56 | 90 |
| Basil | SH 58 | 82 |
| Lettuce | SH 103 | 100 |

### Experiment 6: Addition of Gels to Soil

Dehydrated sheets gels (10 g or 20 g or 30 g) were chopped and mixed with soil to make a total weight of 100 g of material per cell. A control (pure soil) was used to compare germination and growth rates of plants in pure soil and soil enhanced with gels. The growing media was put into a compartment tray for growing plants as multiples of three. Eight seeds were sown in each compartment and covered with foil to enhance humidity levels to facilitate seed germination.

After three days, the germination rate of the seeds was observed and counted to calculate germination percentage.

| | | | No. of | | | |
|---|---|---|---|---|---|---|
| | Gel | | seeds | Seeds | % | |
| Medium | Quantity (g) | Seed Type | sown | Germinated | Germination | Yield (g) |
| Soil | 0 | Lettuce Red | 24 | 18 | 75 | 36.514 |
| | | Green Salad Bowl | | | | |
| Soil + SH | 10 | Lettuce Red | 24 | 21 | 87.5 | 58.582 |
| 56 | | Green Salad Bowl | | | | |
| Soil + SH | 20 | Lettuce Red | 24 | 19 | 79.16 | 44.243 |
| 56 | | Green Salad Bowl | | | | |
| Soil + SH | 30 | Lettuce Red | 24 | 16 | 66.66 | 42.49 |
| 56 | | Green Salad Bowl | | | | |

Overall, the growing soil medium enhanced with gels were found to have better yield than pure soil.

### Experiment 7: Plant Growth

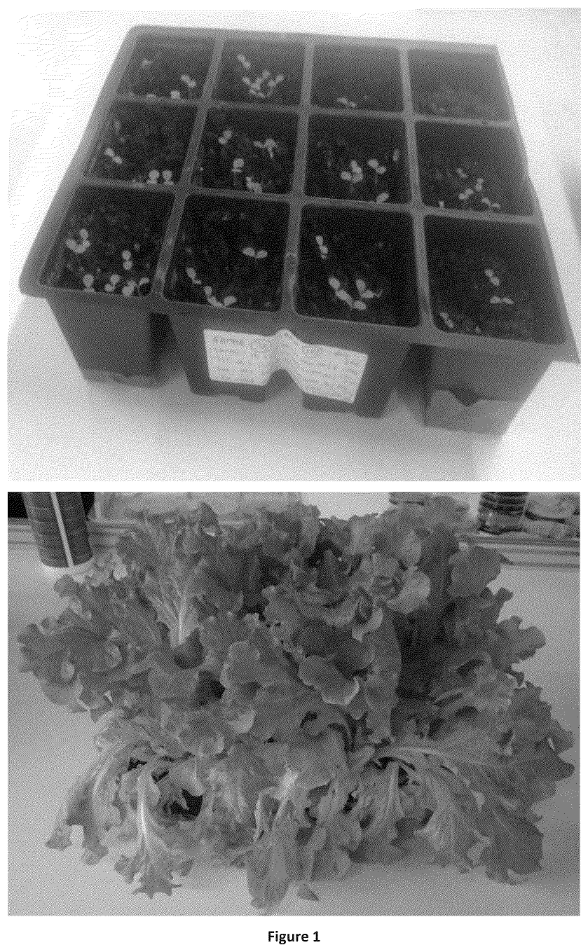

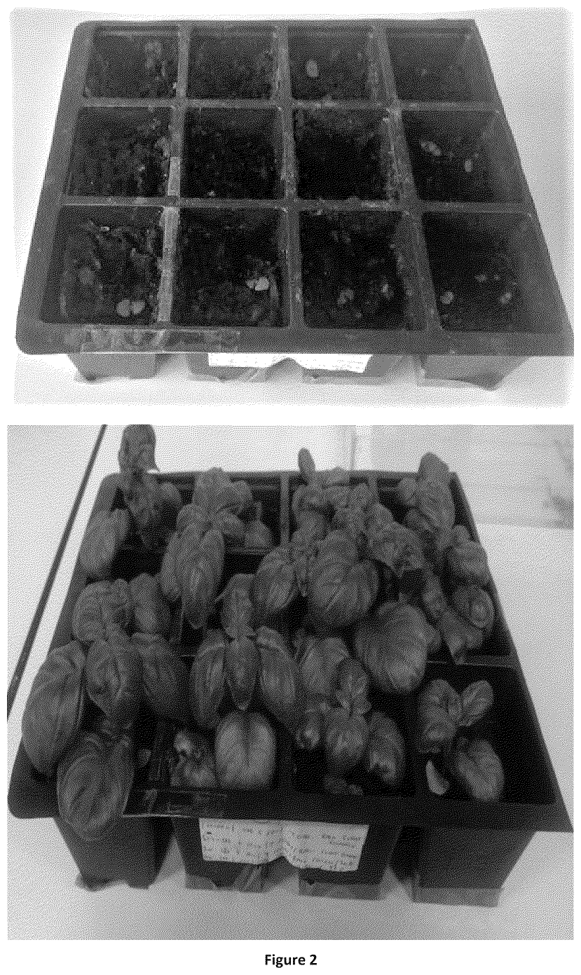

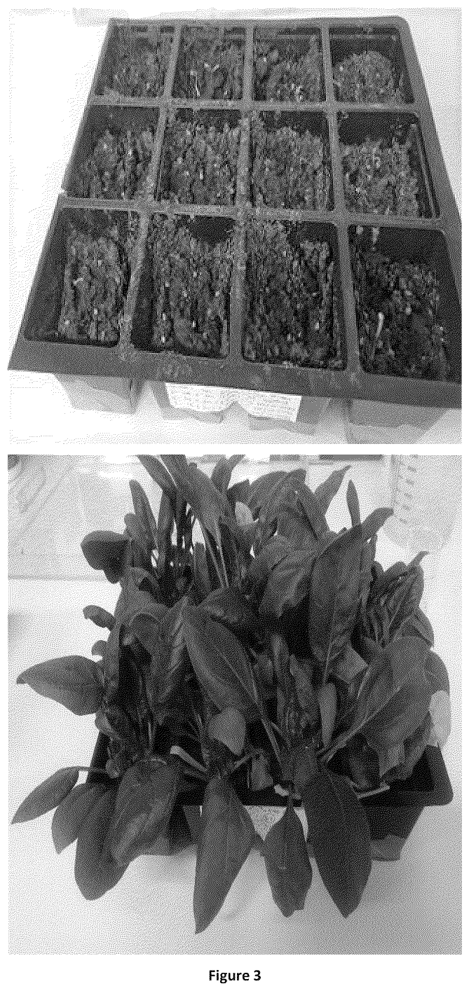

After seed germination in Experiment 6, the cells containing SH 56 (10% w/v) and soil (90% w/v), the lights were turned on in the chamber and temperature was set (23° C.—light time for 16 hours) and 18° C. (dark time for 8 hours). The plants were irrigated with nutrient water as per requirement and left to mature for 4-5 weeks. The full-length plants were grown successfully as shown in FIG. 1 (lettuce), FIG. 2 (basil) and FIG. 3 (spinach).

### Experiment 8: Degradation of Gel in Soil

In this experiment dehydrated flakes of Example 56 were added into soil (10 g dehydrated Example 56 and 90 g soil). Two types of soil were used-Loam (Supa Grow Blended Loam) and John Innes No 2.

All samples were measured for weight daily using a digital scale in the lab to measure weight. There other parameters including the conditions in the chambers i.e., 65% humidity/temperature/light levels were as follows. Lights were turned on in the chamber and temperature was set (23° C.—light time for 16 hours) and 18° C. (dark time for 8 hours). Pot samples were given 10 ml of water on the Monday and Friday of each week

Overall all the samples decreased in weight, with a time until total disintegration of the gel in the soil of 17 weeks.

| | | Weight | Weight | Weight | Weight | Weight | Weight | Weight |
|---|---|---|---|---|---|---|---|---|
| Initial | | end | end | end | end | end | end | end |
| weight | | Week 2 | Week 5 | Week 7 | Week 9 | Week 10 | Week 17 | week 18 |
| (Day 1) | Day 2 | (g) | (g) | (g) | (g) | (g) | (g) | (g) |
| 0.836 | 2.368 | 1.426 | 0.992 | 0.983 | 0.962 | 0.814 | 0.217 | 0.10 |

### Statements

What is stated is:
Statement 1. A growing medium comprising at least 50% w/w plant-derived hydrogel.
Statement 2. A growing medium as stated in statement 1 comprising at least 80% w/w plant-derived hydrogel.
Statement 3. A growing medium as stated in statement 1 or statement 2 wherein the plant-derived hydrogel comprises cellulose or a derivative thereof, starch, soy, plant protein, lignin, pectin, carrageenan, and/or gum.
Statement 4. A growing medium as stated in any one of the preceding statements wherein the plant-derived hydrogel comprises methyl cellulose, xanthan gum, kappa carrageenan, sodium carboxymethyl cellulose and/or carboxymethyl cellulose.
Statement 5. A growing medium as stated in any one of the previous statements, wherein the plant-derived hydrogel comprises methyl cellulose and kappa carrageenan.
Statement 6. A growing medium as stated in any one of the previous statements, additionally comprising biochar, Psyllium, chitosan, barley seed powder, graphene, graphene oxide, reduced graphene oxide, agar, silk fibroin, genipin, honey, coconut oil, tea tree oil, charcoal, activated charcoal, vanillin, glycerol, clays, jute fibre and/or cotton.
Statement 7. A growing medium as stated in any one of the previous statements, additionally comprising biochar.
Statement 8. A growing medium comprising:
   1-2.5% w/v methylcellulose;
   0.5-2% w/v kappa carrageenan; and
   0.25-0.75% w/v biochar;
made to volume with water.
Statement 9. A growing medium comprising:
   0.1-0.5% w/v methylcellulose; and
   1-1.5% w/v kappa carrageenan;
made to volume with water.
Statement 10. The use of a growing medium as stated in any one of statements 1-9 in agriculture.
Statement 11. The use of a growing medium as stated in any one of statements 1-9 in vertical farming.
Statement 12. The use of a growing medium as stated in any one of statements 1-9 in growing plants from seed.
Statement 13. A kit comprising:
i) a growing medium as stated in any one of statements 1-9; and optionally
ii) instructions for use.
Statement 14. A kit comprising:
i) a growing medium as stated in any one of statements 1-9 in dehydrated form; and optionally
ii) seeds; and optionally
ii) instructions for use.
Statement 15. A process for preparing a growing medium as stated in any one of statements 1-9, which comprises mixing:
   one or more plant-derived super absorbent polymers;
   and optionally additional ingredients selected from biochar, Psyllium, chitosan, barley seed powder, graphene, graphene oxide, reduced graphene oxide, agar, silk fibroin, genipin, honey, coconut oil, tea tree oil, charcoal, activated charcoal, vanillin, glycerol, clays, jute fibre and/or cotton
with water and allowing to set.

1. A growing medium comprising methylcellulose and kappa carrageenan, wherein the growing medium does not comprise soil, peat, coir, rock wool or an acrylate or acrylamide based hydrogel.

2. The growing medium as claimed in claim 1 comprising at least 50% w/w plant-derived hydrogel wherein the plant derived hydrogel comprises methylcellulose, kappa carrageenan and water.

3. The growing medium as claimed in claim 1, additionally comprising a gum.

4. The growing medium as claimed in claim 1, additionally comprising biochar.

5. The growing medium as claimed in claim 1, additionally comprising activated charcoal.

6. The growing medium as claimed in claim 1, additionally comprising lignin.

7. The growing medium as claimed in claim 1, additionally comprising locust bean gum.

8. The growing medium as claimed in claim 1, additionally comprising sodium bicarbonate.

9. The growing medium as claimed in claim 1, additionally comprising salicylic acid.

10. The growing medium as claimed in claim 1, additionally comprising xanthan gum.

11. The growing medium as claimed in claim 1, additionally comprising ammonium bicarbonate.

12. The growing medium as claimed in claim 1, additionally comprising potassium bitartrate.

13. The growing medium as claimed in claim 1, additionally comprising guar gum.

14. The use of a growing medium as claimed in claim 1 in agriculture.

15. The use of a growing medium as claimed in claim 1 in vertical farming.

16. The use of a growing medium as claimed in claim 1 in growing plants from seed.

17. A kit comprising:
i) a growing medium as claimed in claim 1; and optionally
ii) instructions for use.

18. A kit comprising:
i) a growing medium as claimed in claim 1 in dehydrated form; and optionally
ii) seeds; and optionally
ii) instructions for use.

19. A process for preparing a growing medium as claimed in claim 1 which comprises mixing methyl cellulose and kappa carrageenan with water and allowing to set.
